(19) United States
(12) Patent Application Publication
(10) Pub. No.: US 2024/0253232 A1
(43) Pub. Date: Aug. 1, 2024

(54) Method for Ascertaining Control Data for a Gripping Device for Gripping an Object

(71) Applicant: Siemens Aktiengesellschaft, Muenchen (DE)

(72) Inventors: Ingo THON, Grasbrunn (DE); Ralf GROSS, Nürnberg (DE)

(21) Appl. No.: 18/283,226

(22) PCT Filed: Mar. 1, 2022
(86) PCT No.: PCT/EP2022/055162

§ 371 Date: Sep. 21, 2023

(30) Foreign Application Priority Data
Mar. 22, 2021 (EP) 21163930

(51) Int. Cl. B25J 9/16

(52) U.S. Cl. CPC B25J 9/1697; B25J 9/163; B25J 9/1664

(57) ABSTRACT

A method for ascertaining control data for a gripping device for gripping an object includes capturing an image of the object, determining at least one object parameter of the captured object, and ascertaining control data for a gripping device to grip the object at at least one gripping point, where ascertaining the at least one gripping point of the object is performed using information relating to at least one possible stable position of the object, and the possible stable position of the object is established such that all of the position data of the object that can be converted into one another via a movement and/or rotation about a surface normal of a support surface on which the object lies are assigned to the possible stable position.

### CROSS-REFERENCE TO RELATED APPLICATIONS

This is a U.S. national stage of application No. PCT/EP2022/055162 filed 1 Mar. 2022. Priority is claimed on European Application No. 21163930.7 filed 22 Mar. 2021, the content of which is incorporated herein by reference in its entirety.

### BACKGROUND OF THE INVENTION

### 1. Field of the Invention

The present invention relates to a method for ascertaining control data for a gripping device for gripping an object, where the method comprises capturing an image of the object, determining at least one object parameter of the object, and ascertaining control data for a gripping device for gripping the object at at least one gripping point.

### 2. Description of the Related Art

U.S. Pub. No. 2020/0164531 A1 discloses an exemplary system for gripping objects that comprises a perception device for recognizing the identity, a location and an alignment of an object, and a selection system for selecting a grasp pose for a respective object. The grasp pose can be selected by a user, for example. Furthermore, the information regarding grasp poses selected by users can be used to train a corresponding system to automate the determination of grasp poses using this information.

One disadvantage of the prior art is that the determination of the grasp poses for grasping an arbitrary object must ultimately be performed by each user. Firstly, this is very time-consuming and, secondly, this is prone to errors because the assessment by the user may also be erroneous.

### SUMMARY OF THE INVENTION

In view of the foregoing, it is therefore an object of the present invention to provide a method or system that enables an object to be gripped in a simplified manner, where such a method or system can enable more secure, more reliable, more rapid and/or more highly automated gripping, for example, it comparison to the prior art.

This and other objects and advantages are achieved in accordance with the invention by a method for ascertaining control data for a gripping device for gripping an object, where the method comprises capturing an image of the object, determining at least one object parameter for the captured object, and ascertaining control data for a gripping device for gripping the object at at least one gripping point, where ascertaining the at least one gripping point of the object is effected using information regarding at least one possible stable pose of the object.

Furthermore, provision can be made for determining the at least one object parameter and/or ascertaining the control data for the gripping device to be effected using information regarding at least one possible stable pose of the object.

The inventive method is based on the insight that during the analysis of the image of the object, for example, for the identification of the object or the determination of further object parameters, not all possible orientations of the object need be taken into account. Rather, it is possible to assume the object is situated in one of its possible stable poses, e.g., on a planar surface. This considerably restricts the number of possibilities for the possible poses of the object during the corresponding image analysis. Therefore, the restriction of the algorithms used for the image analysis to possible stable poses of the object allows the analysis complexity to be significantly reduced because a large portion of possible poses of the object can be disregarded, here. In this way, corresponding analysis methods for identifying the object and/or determining the pose thereof can proceed more simply and/or more rapidly. The ensuing ascertainment of a corresponding gripping point for this object is thus likewise simplified further by comparison with the prior art.

Here, an object can be any three-dimensional structure having a fixed exterior spatial shape. Objects can be, for example, pieces of material, components, modules, devices or the like.

Capturing the image of the object can be effected, for example, via a camera, a scanner (for example, a laser scanner), a distance radar or a similar device for capturing three-dimensional objects. The captured image can advantageously be a two-dimensional image of the object or can be a two-dimensional image comprising an image representation of the object. Furthermore, the captured image can also be or comprises a three-dimensional representation of the object.

The at least one object parameter can be or comprise, for example, an identifier regarding the object, ID information regarding the object and/or also a name or a short description or description of the object. Here, the identifier can be configured, for example, such that it allows the object to be identified. Here, ID information can be a unique designation, identifier or the like for the respective object or can comprise such information.

Furthermore, the at least one object parameter can comprise, for example, a pose, position or the like regarding the captured object. Such a pose can be provided, for example, by characteristic points and the pose of the characteristic points and/or can, for example, also be defined by a pose or position of a virtual bounding box on the captured image. Furthermore or additionally, such a pose or position can, for example, also be provided by the pose of a central point of the object (e.g., a center of gravity) and of an angle of rotation relative to a defined or definable standard pose.

Furthermore, the at least one object parameter can also comprise a property of the object, such as a color, a material or a material combination or comparable properties. Here, determining the at least one object parameter for the captured object relates to the object represented in the captured image. The at least one object parameter is therefore assigned to the object represented in the captured image in the manner such as it is represented in the captured image.

A gripping device can be configured, for example, as a robot or robotic arm having a corresponding gripper for grasping or mechanically fixing the object. Such a gripper can be formed, for example, like tongs, have one or more suction devices and/or allow or support fixing of an object to be gripped using electromagnetic forces.

A robot or robotic arm can be configured, for example, as a 6-axis robot or 6-axis industrial robot or robotic arm. Furthermore, such a robot or robotic arm can be configured, for example, as a Cartesian robot or with a corresponding gripper. Here, the control data for the gripping device for gripping the object at the at least one gripping point are such data that must be fed to a control device of the gripping device or to a control device for the gripping device in order that, for example, a gripper of the gripping device mechanically fixes the captured object at the at least one gripping point. Such a control device for the gripping device can be designed and configured, for example, as a robot controller, a programmable logic controller, a computer or a similar control device.

Here, the control data can comprise, for example, the coordinates of a point in space for the gripper and also an orientation of the gripper that must be adopted by the gripper to be able to grip the object. Furthermore, the control data can also be the coordinates of the at least one gripping point of the object in space, or comprise these coordinates. Using this information, the control device for the gripping device can then calculate the necessary movement of the gripping device and of the gripper in a known manner. Here, coordinates in space are understood to mean, for example, a coordinate system in which both the object to be gripped and the gripping device are situated.

Control data can then be, for example, coordinates of the at least one gripping point and/or of the at least one model gripping point that have been transformed into this real space. Furthermore, in the calculation of the control data, besides the coordinates of the at least one gripping point, a position of the object in space can also be taken into account in order, for example, to enable unobstructed access to the at least one gripping point for a gripper of the gripping device.

Ascertaining the control data for the gripping device can accordingly be effected, for example, as follows: after capturing the image of the object, a pose of the object is ascertained in the context of determining the at least one object parameter. After determining the at least one model gripping point from the 3D model of the object, the coordinates of the at least one model gripping point can then be converted into corresponding coordinates of the at least one gripping point of the object based on the pose information of the real object. Using these coordinates of the at least one gripping point of the real object and the information concerning the position of the object in relation to the gripping device, the control data for the gripping device can then be ascertained in accordance with the present disclosure.

Stable poses of an object, such as on a surface (e.g., a substantially horizontal plane or surface), denotes those one or more poses of the object in which the object can be situated without spontaneously moving (e.g., tilting or rolling) from the rest position.

Such a stable pose for the object can be ascertained, for example, by the object being fed, e.g., to the surface with an initial movement (e.g., being dropped onto the surface), followed by waiting until the object is no longer moving. By repeatedly performing this process with different initial conditions, it is possible to determine the stable poses of an object in this way. Here, e.g., the object can be moved onto a corresponding surface under a wide variety of initial conditions (e.g., can be thrown or dropped onto the surface). This is followed by waiting until the object is no longer moving. Afterward, the stable pose adopted is then correspondingly captured.

The capture, definition and/or storage of a stable pose can be effected, for example, by the pose adopted being registered. This registration can be effected, e.g., via an image recording, a 3D recording and/or capture of one or more coordinates of the object in the stable pose. Furthermore, the capture of the stable pose can also comprise the assignment of a unique identifier for the stable pose of the object.

Here, all those captured pose data for a specific object that can be converted into one another via a displacement and/or a rotation about a surface normal of the support surface on which the object lies are to be assigned to a specific stable pose. For example, a specific identifier for the associated stable pose can then be allocated to all these poses.

In this case, ascertaining stable poses of an object can be effected, for example, in a partly automated manner by a specific object being selected by a user and then, for example, being dropped onto a surface or thrown onto it under a wide variety of initial conditions. This is followed by waiting until the object has come to rest. Then an image of the object is captured and, via an automatic image analysis method, a check is made to establish whether the pose of the captured object can be transformed into an already captured pose of the object via a displacement and/or rotation about a surface normal of the surface. If that is the case, then the identifier for this stable pose is automatically also assigned to the image now recorded.

If the object pose now captured cannot be correspondingly transformed into the pose of an already captured object or object image, then the image now recorded is assigned a new identifier for the stable pose of the object that is adopted therein. These last steps can then be effected in an automated manner.

In a further embodiment, the ascertaining can, for example, also be effected in an automated manner. This can be performed by using, for example, a physical simulation of a falling movement of a 3D model of an object onto a surface. In the context of this simulation, this is then followed by waiting until the movement of the 3D model of the object has come to rest. Then a corresponding image of the now resting 3D model of the object is recorded and an identifier for a stable pose is assigned to the image in accordance with the above-described embodiments of the method. This process can now be repeated automatically with randomly selected initial conditions until no more new stable poses are found or there is a sufficient amount of images for each of the stable poses found.

There may be a sufficient amount of images, for example, if 2, 10 or else 50 images are present for each stable pose. Furthermore, it is possible to stipulate that a new stable pose is no longer found if no new stable pose is found any more after 10, 50 or else 100 attempts.

By way of example, furthermore, the images assigned to a specific stable pose can be correspondingly stored in a database. This database can then be used, for example, in order to assign a specific stable pose to a newly captured object via comparison with these images.

Furthermore, the images can be used to train a corresponding neural network therewith, where the neural network can then be used in the context of the image evaluation for newly recorded images of objects. Using such a neural network, by way of example, a recorded image of a resting object on a surface can then be fed to the neural network. The result of the evaluation by the neural network can then be at least inter alia an identifier for the stable pose adopted by this object.

One advantage of the use of the stable poses in the context of a method in accordance with the disclosed embodiments is, e.g., that only the relatively few stable poses in comparison with all possible poses need be taken into account in the identification, position determination and/or determination of the gripping point. This can reduce, often even considerably reduce, the computational complexity in the position determination, identification and/or determination of the gripping point.

The information regarding a stable pose of an object can, for example, be configured as one or more image representations of the object, where the object in the each of the image representations is situated in the stable pose. Furthermore, an identifier for this stable pose can be assigned to each of the image representations. The information regarding at least one possible stable pose can then be configured, for example, as one or more image representations of an object in which each image representation is assigned an identifier for the stable pose in which the object in this image is situated.

Furthermore, the information regarding at least one possible stable pose of an object can be configured as a “machine learning” (ML) model, where the ML model was trained and/or configured via the application of a machine learning method to ascertained information regarding the at least one possible stable pose. A possible embodiment and corresponding dealing with such ML models will be discussed in even greater detail below. By way of example, such an ML model can be configured as a neural network.

The use of information regarding the at least one possible stable pose of the object is understood here to mean each use of such information in the context of calculating or ascertaining data or information. In this regard, for example, in the context of identifying an object, or otherwise in the context of determining a pose of the object, it is possible to use a collection of items of comparison information or comparison images that show the object or a plurality of objects in their respective stable poses. Corresponding further data can then be derived based on information assigned to the respective images. Such information assigned to the respective images can be, for example, information about the object represented therein, the stable pose adopted by the object, or a spatial pose of the object in the image representation.

In an alternative embodiment, for example, a machine learning model (ML model) can be trained with corresponding data mentioned above, i.e., for example, with image representations showing one or more objects in their respective stable poses, where the image representations are each assigned further information, such as an identifier about the stable pose adopted, an identifier of the object represented therein and/or also information about a real spatial pose adopted in the image representation. An ML model trained in this way can then be used to evaluate the image representation of a recorded object, for example. Such an image evaluation is likewise an example of a use of information regarding the at least one possible stable pose of an object.

In a comparable manner, for example, each determination of the at least one object parameter for the captured object can be performed using information regarding the at least one possible stable pose of the object. In this regard, for example, with the abovementioned database of captured image representations of the object in its stable poses, or the abovementioned ML model, the at least one object parameter for the captured object can be determined so as to ascertain for the object an identifier for its stable pose, a distance angle with respect to a defined zero point and/or a rotation angle relative to a surface normal with respect to the placement surface of the object. Based on this information, it is then possible to define, for example, transformation data for a transformation of the 3D model including the model gripping points defined there into the real object. With the aid of these transformation data, e.g., the at least one gripping point of the object can then be ascertained. In a comparable manner, the control data for the gripping device can then also be ascertained from the transformation data and further information with regard to accessibility of the object, for example.

In a further embodiment, the at least one gripping point can additionally be ascertained by selecting a 3D model for the object using the at least one object parameter, determining at least one model gripping point from the 3D model of the object, and by determining the at least one gripping point of the object using the model gripping point.

The presently contemplated embodiment of the method in accordance with the invention has the advantage, as already explained above, that the use of the model gripping point from the 3D model of the identified object enables a simplified determination of the at least one gripping point of the captured object. Here, gripping points already defined during the configuration of the object can be used later in order to grasp a corresponding real object. Furthermore, one or more model gripping points for the 3D model can be ascertained, for example, in an automated manner, for example, using physical simulations with the 3D model. In this embodiment, no user intervention is necessary, for example, which further simplifies the determination of the at least one gripping point.

With the method in accordance with disclosed embodiments, for example, after capturing an image and for example identifying an object, a matching 3D model of this object can be selected. Data necessary for gripping this object can then be ascertained for, example, such that a corresponding model gripping point is inferred from the 3D model and then a gripping point at the real object is ascertained from the model gripping point. This can be, configured, for example, such that by comparing a captured pose of the object with the 3D model, control data for a gripping device and/or transformation data for ascertaining the control data are ascertained such that they can be used to convert the coordinates of a model gripping point into those of a corresponding gripping point at the object.

The disclosed embodiments of the method have the advantage, for example, that by using the model gripping point from the 3D model, a method for gripping the corresponding object can be simplified by comparison with the prior art. Here, for example, by comparing the recognized or identified object with the 3D model of the object, it is possible for real gripping points of the object to be determined. In this way, in each case for the wide variety of positions and poses of the object in space, based on just one template, i.e., the 3D model for the object, the matching gripping point can be determined in each case.

The inventive method has the further advantage that it also enables gripping points for a captured object to be ascertained in an automated manner. By virtue of the fact that corresponding gripping points can already be provided or defined for the 3D model of the object, it is possible, by comparing the 3D model with a captured position of the object, to convert the model gripping points provided into real gripping points of the captured object, without the need for a further user intervention, for example, an identification or input of possible gripping points by a user.

A 3D model can be any digital presentation or representation of the object that substantially represents at least the exterior shape. The 3D model advantageously represents the exterior shape of the object. Furthermore, the 3D model can also contain information about the internal structure of the object, mobilities of components of the object or else information about functionalities of the object.

The 3D model can be stored, e.g., in a 3D file format, for example, may have been created using a 3D CAD software tool. Examples of such software tools are, for example, SolidWorks (file format: .sldprt), Autodesk Inventor (file format: .ipt), AutoCAD (file format: .dwg), PTC ProE/Creo (file format: .prt), CATIA (file format: .catpart), SpaceClaim (file format: .scdoc) or SketchUp (file format: .skp). Further file formats can be, for example: .blend (Blender file), .dxf (Drawing Interchange Format), .igs (Initial Graphics Exchange Specification), .stl (Stereolithography format), .stp (Standard for the Exchange of Product Model Data), .sat (ACIS text file) or .wrl, .wrz (Virtual Reality Modeling Language). Advantageously, it is possible to use file formats in which material properties of the object such as relative density, color, material and/or the like of the object or of its components are concomitantly stored. By using such 3D models, it is possible to implement, e.g., physically correct simulations for the object, e.g., for determining one or more stable poses of the object on a surface.

Selecting the 3D model for the object can be effected, for example, using ID information for the object, where the at least one object parameter comprises this ID information. The selection of the 3D model of the object can, for example, also be performed using information regarding the at least one possible stable pose of the object. Here, for example, via one of the method sequences explained above, using information regarding the at least one possible stable pose of the object, ID information of the object can be ascertained and, based on this ID information, a corresponding 3D model can then be selected, for example, from a corresponding database.

Here, the 3D model can be taken, for example, from a database for 3D models of different objects, where the selection from this database can be effected, for example, using the ascertained ID information mentioned above. Furthermore, the 3D model can alternatively also be selected by a user. Here, the user can select the 3D model from among a plurality of available 3D models, for example.

A model gripping point can, for example, also be provided by the coordinates of a specific point or region at an exterior surface of the 3D model. Furthermore, the model gripping point can also be provided by a gripping area. Such a gripping area can be defined, for example, by a description of a bounding line of the gripping region on an exterior side of the object.

In order to determine the at least one model gripping point, it can be provided, for example, that one or more gripping points or gripping regions have already been identified in the 3D model of the object and the coordinates of the one or more gripping points or gripping regions are then taken from the 3D model. In one advantageous embodiment, this determination of the at least one model gripping point can be effected in an automated manner. Furthermore, the determination of the at least one model gripping point can, however, also be effected by a user or can be partly automated, in a manner supported by a user.

In this case, ascertaining the model gripping point in the 3D model can be effected, for example, in an automated manner by virtue of corresponding gripping points being ascertained for example by means of a mechanical simulation or model analysis of the 3D model. These gripping points can then furthermore be recorded or identified directly in the 3D model, for example.

Furthermore, model gripping points can also be provided and/or identified as early as in the context of design of the 3D model.

Corresponding model gripping points can, for example, also be added to a 3D model subsequently by virtue of corresponding regions of the 3D model being marked and/or identified as gripping point, for example. This can be effected manually, for example. Furthermore, this can alternatively also be effected in an automated manner by virtue of corresponding gripping points or gripping regions being determined, e.g., via a mechanical simulation of the object or predefined criteria for gripping regions. Such predefined criteria can be, for example, the pose of a center of gravity of the object, the presence of planar regions on the object, and also mechanical strength values of different regions of the object.

Furthermore, a method in accordance with the disclosed embodiments can be configured such that the use of information regarding at least one possible stable pose is configured as the use of an ML model, where the ML model was trained and/or configured via the application of a machine learning method to ascertained information regarding the at least one possible stable pose.

Here, a machine learning method is understood to mean, for example, an automated (“machine”-based) method that does not generate results via rules defined in advance, rather in which regularities are identified (automatically) from many examples via a machine learning algorithm or learning method, on the basis of which regularities statements about data to be analyzed are then generated.

Such machine learning methods can be configured, for example, as a supervised learning method, a partially supervised learning method, an unsupervised learning method or else a reinforcement learning method.

Examples of machine learning methods are, e.g., regression algorithms (e.g., linear regression algorithms), generation or optimization of decision trees, learning methods or training methods for neural networks, clustering methods (e.g., “k-means clustering”), learning methods for or generation of support vector machines (SVMs), learning methods for or generation of sequential decision models or learning methods for or generation of Bayesian models or networks.

The result of such an application of such a machine learning algorithm or learning method to specific data is designated, in particular in the present disclosure, as a “machine learning” model or ML model. Here, such an ML model represents the digitally stored or storable result of the application of the machine learning algorithm or learning method to the analyzed data. In this case, the generation of the ML model can be configured such that the ML model is formed anew by the application of the machine learning method or an already existing ML model is altered or adapted by the application of the machine learning method.

Examples of such ML models are results of regression algorithms (e.g., a linear regression algorithm), neural networks, decision trees, the results of clustering methods (including, e.g., the obtained clusters or cluster categories, cluster definitions and/or cluster parameters), support vector machines (SVMs), sequential decision models or Bayesian models or networks.

In this case, neural networks can be, e.g., “deep neural networks”, “feedforward neural networks”, “recurrent neural networks”, “convolutional neural networks” or “autoencoder neural networks”. Here, the application of corresponding machine learning methods to neural networks is often also referred to as the “training” of the corresponding neural network. Decision trees can be configured, for example, as “iterative dichotomizer 3” (ID3), classification or regression trees (CART) or else “random forests”.

A neural network is understood to mean, at least in association with the present disclosure, an electronic device that comprises a network of nodes, where each node is generally connected to a plurality of other nodes. The nodes are also referred to as neurons or units, for example. Here, each node has at least one input connection and at least one output connection. Input nodes for a neural network are understood to be such nodes that can receive signals (data, stimuli, patterns or the like) from the outside world. Output nodes of a neural network are understood to be such nodes which can pass on signals, data or the like to the outside world. So-called “hidden nodes” are understood to be such nodes of a neural network that are designed neither as input nodes nor as output nodes.

In this case, the neural network can be established, for example, as a deep neural network (DNN). Such a “deep neural network” is a neural network in which the network nodes are arranged in layers (where the layers themselves can be one-, two- or even higher-dimensional). Here, a deep neural network comprises at least one or two hidden layers comprising only nodes that are not input nodes or output nodes. That is, the hidden layers have no connections to input signals or output signals.

Here, “deep learning” is understood to mean a class of machine learning techniques that utilizes many layers of nonlinear information processing for supervised or unsupervised feature extraction and transformation and for pattern analysis and classification.

The neural network can, for example, also have an autoencoder structure. Such an autoencoder structure can be suitable, for example, for reducing a dimensionality of the data and thus recognizing similarities and commonalities, for example.

A neural network can, for example, also be formed as a classification network, which is particularly suitable for classifying data in categories. Such classification networks are used, for example, in connection with handwriting recognition.

A further possible structure of a neural network can be, for example, the embodiment as a “deep believe network”.

A neural network can, for example, also have a combination of a plurality of the structures mentioned above. In this regard, for example, the architecture of the neural network can comprise an autoencoder structure to reduce the dimensionality of the input data, which structure can then furthermore be combined with a different network structure in order, for example, to recognize special features and/or anomalies within the data-reduced dimensionality or to classify the data-reduced dimensionality.

The values describing the individual nodes and the connections thereof, including further values describing a specific neural network, can be stored, for example, in a value set describing the neural network. Such a value set then represents an embodiment of the neural network, for example. If such a value set is stored after training of the neural network, then, for example, an embodiment of a trained neural network is thus stored. In this regard, it is possible, for example, in a first computer system, to train the neural network with corresponding training data, then to store the corresponding value set assigned to this neural network, and to transfer it as an embodiment of the trained neural network into a second system.

A neural network can generally be trained by a procedure in which, via a wide variety of known learning methods, parameter values for the individual nodes or for the connections thereof are ascertained via inputting input data into the neural network and analyzing the then corresponding output data from the neural network. In this way, a neural network can be trained with known data, patterns, stimuli or signals in a manner known per se nowadays in order for the network thus trained to then subsequently be used, for example, for analyzing further data.

Generally, the training of the neural network is understood to mean that the data with which the neural network is trained are processed in the neural network with the aid of one or more training algorithms to calculate or alter bias values, weight values (“weights”) and/or transfer functions of the individual nodes of the neural network or of the connections between in each case two nodes within the neural network.

For training a neural network, e.g., in accordance with the present disclosure, one of the methods of “supervised learning” can be used, for example. In this context, via training with corresponding training data, a network acquires by training results or capabilities assigned to these data in each case. Such a supervised learning method can be used, for example, in order that a neural network acquires by training the stable poses of one or more objects, for example. This can be done, for example, by an image of an object in a stable pose “acquiring by training” an identifier for the adopted stable pose (the abovementioned “result”).

Furthermore, a method of unsupervised learning can also be used for training the neural network. Such an algorithm generates, for a given set of inputs, for example, a model that describes the inputs and enables predictions therefrom. Here, there are clustering methods, for example, which can classify the data in different categories if they differ from one another by way of characteristic patterns, for example.

During the training of a neural network, supervised and unsupervised learning methods can also be combined, for example, if trainable properties or capabilities are assigned to portions of the data, while this is not the case for another portion of the data.

Furthermore, methods of reinforcement learning can also be used, at least inter alia, for the training of the neural network.

By way of example, training that requires a relatively high computing power of a corresponding computer can occur on a high-performance system, while further work or data analyses with the trained neural network can then be performed perfectly well on a system with lower performance. Such further work and/or data analyses with the trained neural network can be effected, for example, on an edge device and/or on a control device, a programmable logic controller or a modular programmable logic controller or further corresponding devices in accordance with the present description.

For the training of the ML model via the machine learning method, a collection of images can be used, for example, which shows a specific object in each case in a stable pose on a planar surface, where each of the images is assigned an identifier for the stable pose adopted therein. The ML model is then trained with this collection of images. Then a stable pose of this object can subsequently be determined by applying the trained ML model to a captured image of the object.

In the case of the abovementioned collection of images, for example, each of the images can show a representation of the object in one of its stable poses on a given or predefinable surface, in particular on a planar surface or on a substantially horizontal, planar surface. The collection of images then contains, e.g., a plurality of image representations of the object in each case in one of its stable poses and furthermore in each case at different angles of rotation relative to a defined or definable initial pose on a surface. The rotation can be defined, e.g., with respect to a surface normal of a surface on which the object lies in one of its stable poses.

The ML model here can be formed as a neural network, for example, where the machine learning method in this case can be, for example, a supervised learning method for neural networks.

In a further advantageous embodiment, the collection of images used for training the ML model can show different objects, each in different stable poses, where each of the images can be assigned both ID information regarding the imaged object and an identifier regarding the stable pose adopted therein. By applying an ML model trained with such a collection of images to a specific captured object, it is then possible to ascertain a determination of ID information of the object and also an identifier for the stable pose adopted by this object.

For this purpose, the collection of images can be configured, for example, such that each of the images shows a representation of one of the objects in one of its stable poses on a given or predefinable surface, in particular on a planar surface or on a substantially horizontal, planar surface. The collection of images can then contain, e.g., a plurality of image representations of the different objects in each case in one of its stable poses and in each case at different angles of rotation relative to a defined or definable initial pose. The rotation can be defined, e.g., with respect to a surface normal of a surface on which the object lies in one of its stable poses.

Here, too, the ML model can be formed, for example, as a neural network, where the assigned machine learning method here can also be, for example, a method of supervised learning for neural networks.

In one advantageous embodiment, ascertaining the at least one gripping point of the object using the model gripping point is effected using a further ML model, where the further ML model was trained or configured via the application of a machine learning method to transformation data regarding possible transformations of a predefined or predefinable initial position into possible poses of the object.

Furthermore or as an alternative thereto, ascertaining the at least one gripping point of the object is effected with the aid of the application of an image evaluation method to the captured image of the object. Here, the further ML model can be configured according to an ML model in accordance with the present disclosure.

In a further embodiment, the further ML model can be configured as a transformation ML model, for example, which is configured for ascertaining transformation data from a defined or definable initial position of the object into the position of the captured object in the real world. In one advantageous embodiment, the further ML model can then additionally be configured as a neural network or as a “random forest” model. In a further advantageous embodiment, the further ML model can, for example, also be configured as a “deep learning” neural network.

The use of the further ML model for ascertaining the at least one gripping point can be configured, for example, as an application of the captured image of the object to the further ML model.

The result of such an application can be, for example, transformation data for a transformation of the predefined or predefinable initial position of the object into the adopted pose of the object captured by the camera.

Alternatively, input data for the application of the further ML model can, for example, also be the data mentioned below: recognition data regarding the object, an identifier regarding the stable pose in which the object is situated, and/or an angle of rotation relative to the support surface in relation to a defined or definable initial pose. Here, recognition data for the object can be, e.g., for example ID information regarding the object, description data for a virtual box around the object and/or scaling data.

Output data of such a further ML model can then be, for example, transformation data for the abovementioned transformation of the object from the predefined or predefinable initial pose into the real position of the object on the placement surface. The predefined or predefinable initial pose can be, for example, a predefined or predefinable pose of a 3D model of the object in corresponding 3D software. Such software can be, for example, a corresponding CAD program or a 3D modeling program.

The training of the further ML model can be effected, for example, by a procedure in which, in a collection of images, each image is either assigned the transformation data of a predefined or predefinable pose of a 3D model of an object represented in the image into the pose of the object in the image. Alternatively or additionally, e.g., in the collection of images, the general positioning data with respect to a chosen coordinate system can be assigned to each image for an object represented therein. Here, the assignment of the abovementioned data to the images of the image collection can be effected, e.g., automatically in a simulation environment or else manually, e.g. , as explained elsewhere in the present disclosure.

As an image evaluation method mentioned above for ascertaining the at least one gripping point of the object, it is possible to use, for example, a method that is usually used for such applications. Examples of such methods are, for example, the SURF, SIFT or BRISK method.

A method in accordance with the disclosed embodiments can furthermore be configured such that determining the at least one object parameter furthermore comprises ascertaining position data of the object.

Moreover, the position data can furthermore comprise information regarding a stable pose adopted by the object.

Ascertaining the control data for the gripping device is simplified further if determining the at least one object parameter for the captured object already comprises ascertaining the position data of the object. As a result, in this context additional data are ascertained that can, if appropriate, accelerate and/or simplify the ascertainment of the control data. If the position data furthermore comprise information regarding a stable pose adopted by the object, which furthermore simplifies the ascertainment of the control data for the gripping device. As explained in the context of the disclosed embodiments, the knowledge about the stable pose in which an object is situated facilitates, accelerates and/or simplifies the analysis of the data for example regarding an identity, a pose or position in space, an angle of rotation and/or a pose of the center of gravity of the object.

Position data of the object, in this case, can comprise, for example, data regarding a position of the object in space. Here, such data regarding a position of the object can comprise, for example, coordinates of one or more reference points of the object in space. By way of example, the data regarding a position can comprise at least coordinates regarding at least three reference points of the object. Furthermore, data regarding a position can, for example, also comprise coordinates of reference point of the object and also one or more rotation angles or angles of rotation relative to one or more axes.

In one advantageous embodiment, the position data of the object can comprise, for example, coordinates of a reference point of the object, information regarding a stable pose of the object and also at least one rotation angle or angle of rotation of the object, in particular exactly one rotation angle or angle of rotation. Here, a rotation angle or angle of rotation can be defined, for example, relative to a surface on which the object is situated. Here, the rotation angle or angle of rotation can be defined, for example, relative to an axis perpendicular to the surface.

Furthermore, in a further advantageous embodiment, the position data of the object comprise data describing a virtual box around the object. In addition thereto, the position data can then comprise information regarding a stable pose of the object and/or at least one rotation angle or angle of rotation of the object, in particular exactly one rotation angle or angle of rotation. In a further advantageous embodiment, the position data of the object can consist of exactly the above-mentioned data.

Such a virtual box around the object can be defined, for example, as a rectangular contour that encloses at least a predetermined portion of the object, in particular encloses the entire object. Instead of a rectangular box, for example, it is also possible to use any desired polygonal or furthermore generally shaped contour, in particular a regularly shaped contour (e.g., also a circle or an ellipse).

Ascertaining the position data can be effected, for example, using the image of the object and a corresponding image evaluation method. Here, for example, a position of the object in the image is ascertained with the aid of the image. Then, e.g., via a calibration of the position of the camera and of the viewing angle of the camera, it is then possible to calculate or ascertain a position of the object on a real repository.

In this case, as already explained in greater detail in the context of this disclosure, the position data of the object can be provided, for example, by the data of a virtual box enclosing the object, e.g., together with an angle of rotation of the object and an identifier regarding a stable pose of the object.

In a further embodiment, determining the at least one object parameter, ascertaining ID information, ascertaining the position data, determining a pose of the object, determining a virtual bounding box around the object and/or determining a stable pose adopted by the object are/is effected using the information regarding at least one possible stable pose.

As already mentioned a number of times in the context of the present disclosure, the use of information regarding the at least one possible stable pose of the object can simplify determining the at least one object parameter, ID information, position data, a pose of the object, a virtual bounding box of the object, and/or determining a stable pose adopted by the object.

One reason for this is, for example, that the observed shape of the object in each case influences the calculation of the variables mentioned. Moreover, in accordance with the inventors' insight, it is sufficient for not all of the possible poses of an object to be taken into account, but rather only those in which the object is situated in a stable pose in accordance with the present description. This reduces the number of possible poses or representations—to be taken into account—of the object in a camera image representation by comparison with all of the possible poses that can theoretically be adopted by the object. This reduction can also be considerable in some instances, especially if an object cannot adopt a particularly large number of stable poses.

In this way, the method for gripping the object is simplified further. Furthermore, an acceleration of the method can also be achieved here, because possible computation operations for calculating the variables mentioned above can be accelerated as a result.

Moreover, in further embodiment of the method in accordance with the present disclosure, when capturing the image of the object, further objects are captured and, in the context of determining the at least one object parameter of the object, furthermore in each case at least one further object parameter regarding each of the further objects is also ascertained. Furthermore, after ascertaining the further object parameters regarding the further objects, selecting the object is effected.

Here, the at least one object parameter or the respective at least one further object parameter can be, for example, an identifier regarding the respective object or ID information regarding the respective object.

The presently contemplated embodiment allows a further simplification of the method because, in this way, a specific object can be gripped even if there are still other objects situated in the image field of the camera.

In a further advantageous embodiment of the method, for example, an image of the object and of further objects is captured, and then at least one object parameter is ascertained for each of the captured objects. On the basis of this object parameter, it is then possible, for example, to identify each of the objects and to select the object in a subsequent selection step. In a particularly advantageous embodiment, the object parameter ascertained for each of the objects can then be or comprise ID information of the object. This then makes the selection of the object particularly simple.

The capturing of further objects during the capturing of the image of the object can be configured, for example, such that the further objects are situated in the captured image of the object, for example, because they are situated in direct proximity to the object.

Furthermore, by way of example, the capture of the image of the object can also be formed as a video recording of the object, from which, for example, a still image of the object is then extracted or is extractable in a further step. In the context of such a video, for example, the further objects can then be captured as well. The video can be generated for example such that, for example, the placement surface moves relative to the camera, for example, is formed as a transport or conveyor belt. Alternatively, for example, the camera can also move in a linear movement or in a rotational movement and capture the object and the further objects in this way.

As already explained above, ascertaining the respective at least one further object parameter can comprise ID information concerning each of the further objects. Furthermore, ascertaining the respective at least one further object parameter concerning each of the further objects can comprise descriptive data for a bounding box around each of the further objects. Furthermore, ascertaining the respective at least one further object parameter concerning each of the further objects can also comprise position data for each of these objects and/or a stable pose adopted by the respective object.

Selecting the object can be effected by a user, for example. This can be achieved, for example, by the captured image of the object and of the further objects being represented on a display device and the user then selecting there the object to be gripped. Furthermore, selecting the object can also be effected automatically. By way of example, a specific object to be gripped can be predefined, for example, by its ID information, a name or else a shape. On the basis of the ascertained object parameters concerning the captured objects, the object to be gripped can then be automatically selected by the system.

Furthermore, it can be provided that, using a method in accordance with the disclosed embodiments, at least one gripping point of the object is ascertained and then the object is subsequently gripped by a gripping device, where the gripping device engages at the at least one gripping point for the purpose of gripping the object.

The gripping device can engage at the object, for example, such that, by way of example, via a gripper that is like tongs, in the context of engaging at one or more of the gripping points, a frictionally locking connection to the object is produced such that as a result the object can be moved and/or raised by the gripping device. Such a frictionally locking connection can, for example, also be produced via one or more suction apparatuses that engage at the one or more gripping points. By way of magnetic forces, such a frictionally locking connection can also be produced, for example, which then enables the object to be transported with the aid of the gripping device.

The objects and advantages are achieved in accordance with the invention by a system for gripping an object, comprising an optical capture device for capturing an image of the object, a data processing device for determining the at least one object parameter of the object and/or for ascertaining control data for a gripping device for gripping the object, where the system is to implement the method in accordance with the disclosed embodiments.

Here, the optical capture device, the image of the object, the at least one object parameter of the object, the control data and also the gripping device can be configured, for example, in accordance with the disclosed embodiments. The data processing device can be, for example, a computer, a PC, a controller, a control device, a programmable logic controller (PLC), a modular programmable logic controller, an edge device or a comparable device. Here, the data processing devices and the elements and/or components thereof can furthermore be configured in accordance with the disclosed embodiments.

In one advantageous embodiment, the data processing device can comprise, for example, an ML model in accordance with the disclosed embodiments. By way of example, the data processing device can be configured as a programmable logic controller, where the ML model can be provided, for example, in a central module of the programmable logic controller. Alternatively, the ML model can also be provided in a functional module that is connected to an abovementioned central module of the programmable logic controller via a backplane bus of the programmable logic controller.

For implementing the method, the data processing device can comprise a corresponding execution environment, for example, which is configured for running or executing software, for example, during the running or execution of which a method in accordance with the disclosed embodiment is performed.

Here, the data processing device can also comprise a plurality of components or modules (e.g., comprising one or more controllers, edge devices, PLC modules, computers and/or comparable devices). Such components or modules can then be connected, for example, via a corresponding communication connection, e.g., an Ethernet, an industrial Ethernet, a field bus, a backplane bus and/or comparable devices. In a further embodiment, the communication connection can, for example, furthermore be configured for real-time communication.

In a further embodiment, for example, the system in accordance with the present disclosure comprises a gripping device and the system is furthermore configured for performing a method in accordance with the disclosed embodiments. Here, the gripping device can be configured, for example, in accordance with the present disclosure.

Furthermore, the data processing device can be configured as a modular programmable logic controller having a central module and a further module, and furthermore determining the at least one object parameter of the object is effected using the further module.

It can also be provided that the data processing device comprises a modular programmable logic controller having a central module and a further module, and that furthermore determining the at least one object parameter of the object is effected using the further module.

A programmable logic controller (PLC) is a control device that is programmed and used to control an installation or machine by closed-loop or open-loop control. In such a PLC, specific functions, such as sequence control, for example, can be implemented so that both the input signals and the output signals of processes or machines can be controlled in this way. The programmable logic controller is defined in the standard EN 61131, for example.

In order to link a programmable logic controller to an installation or machine, it is possible to use actuators of the installation or machine, which are generally connected to the outputs of the programmable logic controller, and also sensors of the installation or machine. In principle, the sensors are situated at the PLC inputs, and they furnish the programmable logic controller with information about what is happening in the installation or machine. The following are deemed to be sensors, for example: light barriers, limit switches, probes, incremental encoders, filling level sensors, temperature sensors. The following are deemed to be actuators, for example: contactors for switching on electric motors, electric valves for compressed air or hydraulics, drive control modules, motors, drives.

A PLC can be realized in various ways. That is, it can be realized as an individual electronic device, as software emulation, as a “soft” PLC (or “virtual PLC” or PLC application or PLC app), as a PC plug-in card, etc.

Modular solutions are often also found in the context of which the PLC is assembled from a plurality of plug-in modules. Here, a modular programmable logic controller can be designed and configured such that a plurality of modules can be or are provided, in which case one or more expansion modules can generally be provided besides a central module, which is configured for executing a control program, e.g., for controlling a component, machine or installation (or a part thereof). Such expansion modules can be configured, for example, as a current/voltage supply or else for inputting and/or outputting signals and/or data. Furthermore, an expansion module can also serve as a functional module for undertaking specific tasks (e.g., a counter, a converter, data processing using artificial intelligence methods (comprising, e.g., a neural network or some other ML model) . . . ).

By way of example, a functional module can also be configured as an AI module for implementing actions using artificial intelligence methods. Such a functional module can comprise, for example, a neural network or an ML model in accordance with the disclosed embodiments or a further ML model in accordance with the disclosed embodiments.

The further module can then be provided, for example, for implementing specific tasks in the context of performing the method, e.g., computationally complex subtasks or computationally complex special tasks (such as a transformation, and/or an application of AI methods). For this purpose, the further module can, for example, be specifically configured and/or also comprise a further program execution environment for corresponding software. In particular, the further module can comprise the ML model or the further ML model, for example.

With this embodiment, the system for gripping the object is simplified further because the data processing device can be adapted specifically to an envisaged gripping task. In particular, this is possible without the need to change a central method sequence that can proceed in a central module of the programmable logic controller, for example. Specific subtasks can then proceed in the further module, which can then be configured differently depending on the exact gripping task.

In a further embodiment, the system in accordance with disclosed embodiments can furthermore be configured such that determining the at least one object parameter for the object is effected using an ML model and the further module comprises the ML model.

Furthermore, it can be provided that ascertaining the control data for the gripping device is effected using a further ML model and the further module comprises the further ML model (162). Here, the ML model can be configured, for example, as an ML model in accordance with the disclosed embodiments. Moreover, the further ML model can be designed and configured, for example, as a further ML model 1 in accordance with the disclosed embodiments.

Furthermore, the at least one object parameter, the object, the control data, the gripping device and ascertaining the control data for the gripping device can be configured in accordance with the disclosed embodiments.

The ML model can be configured, for example, as a “recognition ML model”. Such a recognition ML model can be configured, for example, for recognizing a pose of the object and/or a virtual box around the object, a type or ID information regarding the object and/or a stable pose of the object. Furthermore, an ML model in accordance with the disclosed embodiments can comprise such a recognition ML model. Such a recognition ML model can be configured, for example, as a “deep neural network”. By way of example, the captured image of the object can be provided or used as input data for such a recognition ML model. Output data of such a recognition ML model can then be, for example, one, a plurality or all of the above-mentioned parameters.

In a further embodiment, the recognition ML model can configured for recognizing a location, a virtual box, a type and/or ID information in each case concerning a plurality or all of the objects imaged in a captured image. A recognition ML model established in this way can be used advantageously, for example, if further objects are situated in the captured image of the object.

Output data of a recognition ML model formed in this way can then be, for each of the captured objects, for example, the abovementioned information regarding the object: data regarding a location and/or virtual box and/or ID information. In a further method step, for example, this information can then be used to select the object to be gripped from all the captured objects, for example, based on the ascertained ID information. The object parameters that have then already been ascertained by this recognition ML model can then be used in the context of a method in accordance with the disclosed embodiments to ascertain the control data for the gripping device for gripping the object.

Furthermore, the ML model can be configured as an “angle recognition ML model”, for example, which is configured at least inter alia for recognizing an angle of rotation of the object on a surface relative to a defined or definable initial position. An ML model in accordance with the disclosed embodiments can also comprise such an angle recognition ML model. An angle recognition ML model of this type can be configured, for example, as a regression AI model or else a classification AI model.

The captured image of the object can once again be used as input data for such an angle recognition ML model. Here, output data can once again be, for example, a corresponding angle of rotation of the object on the placement surface relative to a defined or definable initial position, or can comprise such an angle of rotation. Furthermore, output data of an angle recognition ML model can also comprise the abovementioned angle of rotation, plus the data that were indicated above, by way of example, from output data of a recognition ML model.

In a further embodiment, the ML model can be configured as a “transformation ML model”, for example, which is configured for ascertaining transformation data from a defined or definable initial position of the object into the position of the captured object on the placement surface in the real world. Input data for such a transformation ML model can be, for example, identifier data for the object, a stable pose of the object and/or an angle of rotation of the object on the placement surface relative to a defined or definable initial position. Identifier data for the object here can be, e.g., ID information, description data for a virtual box around the object, information regarding a stable pose and/or scaling data.

Furthermore, input data for such a transformation ML model can also be captured image data of an object lying on a planar surface. The abovementioned input data, such as the identifier data for the object, a stable pose of the object and/or an angle of rotation of the object, can then be obtained, for example, from these image data in a first step, the further procedure then being in accordance with the explanation above.

Furthermore, the abovementioned captured image data of the object lying on the planar surface can also be used directly as input data for a corresponding transformation ML model.

Output data of such a transformation ML model can then be, for example, transformation data for the abovementioned transformation of the object from the defined or definable initial position into the real position of the object on the placement surface. Such a defined or definable initial position of the object can be, for example, the position of a 3D model of the object in a corresponding 3D modeling program (e.g. 3D CAD software). This also applies, for example, to the initial position used in relation to the angle of rotation.

Such a transformation ML model can be configured, for example, as a “deep neural network” or as a “random forest” model.

An ML model in accordance with the disclosed embodiments can comprise, for example, a recognition ML model and/or an angle recognition ML model and/or a transformation ML model. Moreover, a further ML model in accordance with the disclosed embodiments can comprise, for example, a recognition ML model and/or an angle recognition ML model and/or a transformation ML model.

In one advantageous embodiment, furthermore, an ML model in accordance with the disclosed embodiments can, for example, comprise a recognition ML model and/or an angle recognition ML model or can be configured as such an ML model. In this embodiment, a further ML model in accordance with the disclosed embodiments can, for example, comprise a transformation ML model or can be configured as such a transformation ML model.

In a further embodiment, the system in accordance with the disclosed embodiments can be configured such that the data processing device comprises an edge device or configured as an edge device, and such that furthermore determining the at least one object parameter of the object is effected using the edge device.

An edge device often has a higher computing power in comparison with a more conventional industrial control device, such as a controller or a PLC. As a result, such an embodiment further simplifies and/or accelerates the method in accordance with the disclosed embodiments. In one possible embodiment, it can be provided here that the method in accordance with the disclosed embodiments is implemented completely on such an edge device.

In an alternative embodiment, for example, particularly computationally intensive and/or complex method steps are performed on the edge device, while other method steps are performed on a further component of the data processing device, such as a controller or a programmable logic controller. Such computationally intensive and/or complex method steps can be, for example, method steps using machine learning techniques or artificial intelligence, such as the application of one or more ML models in accordance with the disclosed embodiments.

An edge device can comprise, for example, an application for controlling apparatuses or installations. By way of example, such an application can be configured as an application having the functionality of a programmable logic controller. Here, the edge device can be connected, for example, to a further control device of an apparatus or installation, or directly to an apparatus or installation to be controlled. Furthermore, the edge device can be configured such that it is additionally also connected to a data network or a cloud or is configured for connection to a corresponding data network or a corresponding cloud.

An edge device can furthermore be configured for realizing additional functionalities in connection with controlling for example a machine, installation or component, or parts thereof. Such additional functionalities can be for example, data collection and transfer to the cloud, including e.g. preprocessing, compression, analysis, analysis of data in a connected automation system e.g. using AI methods (e.g. a neural network). For this purpose, an edge device can comprise, e.g., an ML model, e.g., an ML model or a further ML model in accordance with the disclosed embodiments.

Here, such a system comprising an edge device can furthermore be configured such that determining the at least one object parameter of the object is effected using an ML model and the edge device comprises the ML model.

Furthermore, such a system comprising an edge device can also be configured such that ascertaining the control data for the gripping device comprises using a further ML model and the edge device comprises the further ML model.

Here, the ML model can be configured, for example, as an ML model in accordance with the disclosed embodiments. The further ML model can also be configured, for example, as a further ML model in accordance with the disclosed embodiments.

The objects and advantages are further achieved in accordance with the invention by a method for generating training data for an ML model, where the method comprises selecting an object, selecting starting data of the object above a planar surface, producing a falling movement of the object in the direction of the planar surface, capturing an image of the object once the movement of the object on the planar surface has stopped and assigning an identifier to the image, where the identifier comprises ID information for the stable pose adopted by the object.

Here, the ML model can be configured for example in accordance with the disclosed embodiments. Furthermore, the method described for generating training data for an ML model can be configured in accordance with the disclosed embodiments.

The use of an ML model trained with these training data makes it possible to provide a method or system that allows simplified gripping of an object. As already explained in the context of the disclosed embodiments, the restriction of the considered possible poses of an object to stable poses in accordance with the disclosed embodiments has the effect that more rapid, more reliable and/or more highly automated gripping is made possible via a system or method configured in this way.

In one advantageous embodiment, the inventive method is performed a number of times, e.g., in each case with different starting data for the object. In this way, it is possible to generate a larger number of images with an assigned identifier for the training of the ML model. Here, the method can be repeated, for example, sufficiently frequently that a plurality (advantageously even all) of the possible stable poses of the object on the planar surface are represented in at least one of the images. In a further advantageous embodiment, the method can be repeated, for example, sufficiently frequently that as many as possible (advantageously even all) of the possible stable poses of the object on the planar surface are represented in at least two of the images or at least ten of the images.

Here, the ML model, the object, capturing the image, and the ID information for the stable pose adopted by the object can be configured in accordance with the disclosed embodiments.

Furthermore, the starting data can be provided, for example, by a height of the object, for example, of a center of gravity of the object, above the planar surface, an orientation of the object in space and also a vector for an initial velocity of the object.

The falling movement can be, for example, a movement under the influence of the gravitational force. Furthermore, in this case, additional forces, such as friction forces (e.g., in air or in a liquid) and also electromagnetic forces, can furthermore influence the movement. In one advantageous embodiment, the movement is dominated by the gravitational force, for example. In this case, the falling movement begins according to the starting data.

Here, the ML model can, for example, be configured as a recognition ML model in accordance with the disclosed embodiments or can comprise such a model. As such, the identifier assigned to the captured image can comprise further object parameters in accordance with the present description, for example, besides the ID information for the stable pose adopted by the object. In this case, such further object parameters can comprise, e.g., information regarding a pose and/or position of the object, information concerning a pose and/or shape of a virtual box around the object, a type of the object and/or ID information regarding the object.

The ML model can, for example, also be configured as an angle recognition ML model in accordance with the disclosed embodiments or can comprise such a model. As such, the identifier assigned to the captured image can comprise further object parameters in accordance with the present description, for example, besides the ID information for the stable pose adopted by the object. Here, such further object parameters can comprise, e.g., an angle of rotation of the object on the planar surface relative to a defined or definable initial position.

The ML model can furthermore also be configured as a transformation ML model in accordance with the disclosed embodiments or can comprise such a model. In this case, the identifier assigned to the captured image can comprise further object parameters in accordance with the disclosed embodiments, for example, besides the ID information for the stable pose adopted by the object. Here, such further object parameters can comprise, e.g., transformation data for the abovementioned transformation of the object from the defined or definable initial position into the real position of the object on the planar surface. Here, such a defined or definable initial position of the object can also be, for example, the position of a 3D model of the object in a corresponding 3D modeling program (e.g., 3D CAD software).

The identifier parameters and/or object parameters respectively mentioned above can be ascertained at least in part, for example, manually by a user, for example, manually via a measurement or with the aid of an at least partly automated measuring system. Furthermore, such identifier parameters can be ascertained at least in part automatically, for example, via image evaluation methods or via additional automatic measuring systems, such as an optical measuring system, a laser measuring system and/or an acoustic measuring system.

In a further advantageous embodiment, a method for generating training data for a transformation ML model can be configured by selecting an object, selecting starting data of the object above a planar surface, producing a falling movement of the object in the direction of the planar surface, capturing an image of the object once the movement of the object on the planar surface has stopped, and ascertaining at least one object parameter regarding the object using the captured image, where the at least one object parameter comprises identifier data for the object, a pose or position of the object, information regarding a virtual box around the object, an identifier for a stable pose of the object and/or an angle of rotation of the object on the planar surface, and by assigning an identifier to the at least one object parameter ascertained, where the identifier comprises transformation data for a transformation of the object from a defined or definable initial position into a real position of the object on the planar surface.

Here, the real position of the object is described, for example, by the identifier data for the object, the pose or position of the object, the information regarding a virtual box around the object, the identifier for a stable pose of the object and/or an angle of rotation of the object.

Here, identifier data for the object can be or can comprise, for example, ID information, description data for a virtual box around the object, ID information regarding a stable pose and/or scaling data.

The transformation data, the defined or definable initial position, the angle of rotation of the object, the identifier for a stable pose of the object, and the at least one object parameter here can be configured in accordance with the disclosed embodiments. Furthermore, the pose or position of the object and/or the information regarding a virtual box around the object can also be configured in accordance with the disclosed embodiments.

The objects and advantages are further achieved in accordance with the invention are likewise achieved by a method for generating training data for an ML model, where the method comprises selecting a 3D model of an object, selecting starting data of the 3D model of the object above a virtual planar surface, simulating a falling movement of the 3D model of the object in the direction of the virtual planar surface, creating an image of the 3D model of the object once the simulated movement of the 3D model of the object on the virtual planar surface has come to rest, assigning an identifier to the created image, wherein the identifier comprises ID information for the stable pose adopted by the 3D model of the object, and storing the training data comprising the captured image and the identifier assigned thereto.

Here, storing the training data can be effected in a storage device and/or, for example, in a database or data collection for corresponding training data.

Here, the ML model can be configured, for example, in accordance with the disclosed embodiments. Furthermore, the method described for generating training data for an ML model can be configured in accordance with the disclosed embodiments.

As already explained in connection with the disclosed embodiments of the method, the use of an ML model trained with these training data makes it possible to provide a method or system that allows simplified gripping of an object.

In one advantageous embodiment, the disclosed embodiments of method can be performed a number of times, e.g., in each case with different starting data for the object, in order, for example, to generate a plurality of images with assigned identifier for the training of the ML model.

Here, the method can be repeated, for example, sufficiently frequently that a plurality (advantageously even all) of the possible stable poses of the digital model of the object on the virtual planar surface are represented in at least one of the images. In a further advantageous embodiment, the method can be repeated, for example, sufficiently frequently that as many as possible (advantageously even all) of the possible stable poses of the digital model of the object on the virtual planar surface are represented in at least two of the images or at least ten of the images.

In this case, the ML model, the object, capturing the image, and the ID information for the stable pose adopted by the object can also be configured here in accordance with the disclosed embodiments.

The starting data can be provided, for example, by a height of the object (for example, a height of a center of gravity of the object) above the planar surface, an orientation of the object in space and also a vector for an initial velocity of the object.

The falling movement can be simulated, for example, as a movement under the influence of the gravitational force. Furthermore, in this case, additional forces, such as friction forces (e.g., in air or in a liquid) and also electromagnetic forces, can furthermore be taken into account in the simulation. In one advantageous embodiment, the movement is simulated for example only taking into account the gravitational force. In this case, the simulation of the falling movement then begins according to the starting data.

The ML model can, for example, be configured as a recognition ML model in accordance with the disclosed embodiments or can comprise such a model. Here, the identifier with respect to the captured image can comprise further object parameters in accordance with the disclosed embodiments, for example, besides the ID information for the stable pose adopted by the 3D model of the object. Here, such further object parameters can comprise, e.g., information regarding a pose and/or position of the 3D model of the object, information concerning a pose and/or shape of a virtual box around the 3D model of the object, a type of the object and/or ID information regarding the object.

The ML model can for, example, also be configured as an angle recognition ML model in accordance with the disclosed embodiments or can comprise such a model. Here, the identifier assigned to the captured image can comprise further object parameters in accordance with the disclosed embodiments, for example, besides the ID information for the stable pose adopted by the 3D model of the object. Here, such further object parameters can comprise, e.g., an angle of rotation of the 3D model of the object on the virtual planar surface relative to a defined or definable initial position.

The ML model can, for example, also be configured as a transformation ML model in accordance with the disclosed embodiments or can comprise such a model. Here, the identifier assigned to the captured image can comprise further object parameters in accordance with the disclosed embodiments, for example, besides the ID information for the stable pose adopted by the 3D model of the object. Here, such further object parameters can comprise, e.g., transformation data for the abovementioned transformation of the 3D model of the object from a defined or definable initial position into a real position of the object on the placement surface. Here, such a defined or definable initial position of the 3D model of the object can also be, for example, the position of the 3D model of the object in a corresponding 3D modeling program (e.g., 3D CAD software).

In one advantageous embodiment, the identifier parameters and/or object parameters respectively mentioned above can be ascertained automatically, for example. All size data, pose data and other data describing a pose and/or position for the object are known in the digital simulation environment (otherwise a simulation of the object, in particular a physical simulation, would not be possible). Consequently, a position of the object, a pose of the object, an angle of rotation of the object relative to the virtual planar surface, transformation data in accordance with the disclosed embodiments and further comparable object parameters regarding the 3D model of the object can be taken directly from the simulation system. Therefore, it is possible that an above-described method for generating training data using a 3D model of the object proceeds automatically and training data for an ML model in accordance with the disclosed embodiments are generable or are generated automatically in this way.

However, the identifier parameters respectively mentioned above can also be ascertained at least in part manually by a user, such as manually via a measurement or else with the aid of an at least partly automated measuring system. Furthermore, such identifier parameters can be ascertained at least in part automatically, for example, via image evaluation methods or additional automatic digital measuring systems in a simulation environment for implementing the method described here.

In a further advantageous embodiment, a method for generating training data for a transformation ML model can be configured by selecting a 3D model of an object, selecting starting data of the 3D model of the object above a virtual planar surface, simulating a falling movement of the 3D model of the object in the direction of the virtual planar surface, creating an image (132) of the 3D model of the object once the simulated movement of the 3D model of the object on the virtual planar surface has come to rest, ascertaining at least one object parameter regarding the 3D model of the object using the created image, where the at least one object parameter comprises identifier data for the object, a pose or position of the 3D model of the object, information regarding a virtual box around the 3D model of the object, an identifier for a stable pose of the 3D model of the object and/or an angle of rotation of the 3D model of the object on the virtual planar surface, by assigning an identifier to the at least one object parameter ascertained, where the identifier comprises transformation data for a transformation of the 3D model of the object from a defined or definable initial position into an ascertained position of the 3D model of the object on the virtual planar surface, and storing the training data comprising the at least one object parameter and the identifier assigned thereto.

Here, storing the training data can be effected in a storage device and/or, for example, in a database or data collection for corresponding training data.

In this case, the ascertained position of the object is described, for example, by the identifier data for the 3D model of the object, a pose or position of the 3D model of the object, information regarding a virtual box around the 3D model of the object, the identifier for a stable pose of the 3D model of the object and/or an angle of rotation of the 3D model of the object.

Here, identifier data for the 3D model of the object can be or comprise, for example, ID information, description data for a virtual box around the 3D model of the object, ID information for a stable pose and/or scaling data.

In this case, the transformation data, the defined or definable initial position, the angle of rotation of the 3D model of the object, the ID information or identifier for a stable pose of the 3D model of the object and the at least one object parameter can be configured in accordance with the disclosed embodiments. Furthermore, the pose or position of the 3D model of the object and/or the information regarding a virtual box around the 3D model of the object can also be designed and configured in accordance with the disclosed embodiments.

The objects and advantages are further achieved in accordance with the invention by a method for generating training data for an ML model, where the method comprises electing a 3D model of an object, selecting a virtual planar surface, determining a pose of the 3D model of the object in such a way that the 3D model of the object touches the virtual planar surface at three or more points, creating an image of the digital model of the object, assigning an identifier to the image, where the identifier comprises ID information for the stable pose adopted by the 3D model of the object, and by storing the training data comprising the created image and the identifier assigned thereto.

Here, storing the training data can be effected in a storage device and/or, for example, in a database or data collection for corresponding training data.

Here, the ML model can be designed and configured for example in accordance with the disclosed embodiments. Furthermore, the method described for generating training data for an ML model can be configured in accordance with the disclosed embodiments.

In one advantageous embodiment, the inventive method is also performed a number of times to generate, for example, the largest possible number of images with assigned identifier for the training of the ML model. Here, the method can be repeated, for example, sufficiently that frequently a plurality (advantageously even all) of the possible stable poses of the digital model of the object on the virtual planar surface are represented in at least one of the images. In a further advantageous embodiment, the method can be repeated, for example, sufficiently frequently that as many as possible (advantageously even all) of the possible stable poses of the digital model of the object on the virtual planar surface are represented in at least two of the images or at least ten of the images.

The methods for generating training data in accordance with the disclosed embodiments can furthermore be developed such that the respective methods are furthermore configured, in each case, for training an ML model in accordance with the disclosed embodiments, or for training a further ML model in accordance with the disclosed embodiments, such that the ML model or the further ML model is trained using the captured or ascertained image and at least the ID information assigned thereto for the stable pose adopted by the object or that adopted by the 3D model of the object.

Here, the ML model and/or the further ML model can, for example, be designed as a recognition ML model and/or an angle recognition ML model and/or a transformation ML model or comprise such ML models. The ML model and/or the further ML model can thus comprise the function of one, two or even all three of the ML models mentioned.

In a further embodiment, the ML model can be configured, for example, as a recognition ML model and/or an angle recognition ML model, while the further ML model can be configured, for example, as a transformation ML model.

In one advantageous embodiment, the method can be used, for example, for training a recognition ML model in accordance with the designed and, an angle recognition ML model in accordance with the designed and and/or a transformation ML model in accordance with the designed and.

Here, the training of the ML model and/or of the further ML model can furthermore be effected, for example, using the captured image of the object, a position of the object, ID information of the object, an angle of rotation of the object and/or an identifier regarding a stable pose adopted by the object. Here, for the training of the ML model and/or of the further ML model, for example, the position of the object, the ID information of the object, the angle of rotation of the object and/or the identifier regarding the stable pose adopted by the object are/is assigned in this case to the captured image of the object. Such an assignment of parameters—here to the captured image—is very generally also referred to as “labeling”.

For the training of an ML model formed as a recognition ML model, the captured image can be labeled, for example, with a position of the object, ID information of the object and/or an identifier regarding a stable pose adopted by the object.

Furthermore, for the training of an ML model formed as a rotation recognition ML model, for example, the captured image of the object can be labeled with a position of the object, ID information of the object, an angle of rotation of the object and/or an identifier regarding a stable pose adopted by the object.

For the training of an ML model formed as a transformation ML model, the captured image can be labeled, for example, with corresponding transformation data for the transformation of an initial pose of the object into the pose adopted in the captured image.

Furthermore, for the training of an ML model designed as a transformation ML model, at least one object parameter ascertained using the captured or created image in accordance with the disclosed embodiments can be labeled for example with corresponding transformation data for the transformation of an initial pose of the object into the pose adopted in the captured or created image.

The objects and advantages are also achieved in accordance with the invention by the use of training data generated via a method for generating training data in accordance with the disclosed embodiments for training an ML model, in particular an ML model in accordance with the disclosed embodiments.

The objects and advantages are further achieved in accordance with the invention by an ML model, in particular an ML model in accordance with the disclosed embodiments, where the ML model was trained using training data which were generated using a method for generating training data in accordance with the disclosed embodiments.

Moreover, a method or a system for ascertaining control data for a gripping device in accordance with the disclosed embodiments can be configured such that an ML model used in the context of implementing the method in the system was trained using training data which were generated using a method for generating training data in accordance with the disclosed embodiments.

An exemplary possible embodiment of a method and/or of an apparatus in accordance with the disclosed embodiments is presented below.

This exemplary embodiment is based on the problem that, in many production processes, parts are made available by way of “chutes” as transport system. Here, such parts can come, for example, from external suppliers or else from an upstream internal production process. For the further production process, it is necessary, for example, for these parts to be isolated and individually manipulated or transported in a specific manner. Especially for production methods in which this further treatment is effected via robotic arms, accurate information regarding the pose and orientation of the isolated parts is necessary. In such chutes, however, the pose and position of the parts completely random and cannot be stipulated in a predefined manner. Therefore, these data have to be ascertained dynamically in order that these data can be successfully gripped and transported using a robotic arm, for example.

An exemplary method and system for gripping an object in accordance with the disclosed embodiments can be configured, for example, in the context of the present exemplary embodiment, e.g., such that the system can localize objects or parts for which a 3D model of the object or part is available. Such a 3D model may have been created by 3D CAD software, for example. Such a method can be implemented, for example, on various hardware devices, for example a programmable logic controller, a modular programmable logic controller, an EDGE device or else using computational capacity in a cloud, for example, in order to effect the corresponding image processing. Here, a programmable logic controller can be configured, for example, such that the inventive method is performed using artificial intelligence or machine learning techniques in a specific functional module for the programmable logic controller for performing artificial intelligence methods. Such modules can comprise a neural network, for example.

The exemplary system described below can recognize the 6D orientation of arbitrary objects, e.g., using a corresponding 3D model of the object, such that the object can be gripped reliably at a gripping point specified in the 3D model. This allows supply parts corresponding to the system to be supplied to a specific production step, for example, with high repeatable accuracy.

A general set-up of a system for implementing such a method can comprise, for example, the following components:
a.) a transport system for parts to be processed with a planar surface, optionally with a vibratory separating device;
b.) a robotic arm for gripping the parts to be processed;
c.) a camera for capturing image data from the parts to be processed on the transport system for a corresponding camera controller;
d.) a programmable logic controller (PLC) in order to make available respective gripping coordinates of the supply parts and to communicate them to the robot; and
e.) a camera controller for identifying the parts (classification), for determining their orientation (detection/segmentation) and for ascertaining the gripping coordinates.

An exemplary system of this type can thus comprise, for example, the PLC, the camera controller, the camera, software executed on the respective components, and also further software that generates input values for the aforementioned software.

After capturing an image with a plurality of parts, the system described, by way of example, is configured to recognize the parts, then to select a specific part to be gripped, and to determine the gripping points for this part to be gripped. For this purpose, the software and the further software implement the following steps, for example:

1.) Image segmentation: in a first step, the image is segmented using an AI model (“M-Seg”). This segmentation AI model M-Seg here is one example of a recognition ML model in accordance with the disclosed embodiments. It is assumed here that each of the parts is considered in isolation as if it were situated individually or on its own on the placement surface or the supply device. Afterward, for each of the parts, a rectangular virtual bounding box (location in X, Y) is ascertained, a type of the object is determined and a position/scaling in X, Y directions is calculated. Here, the position corresponds to the approximate orientation in the rotation dimension of 6D space, based on the possible stable poses of the parts as explained below. The selected part, in particular the assigned virtual bounding box, for example, then defines the “region of interest” (ROI), to which the subsequent steps are applied.

2.) In a further, optional step, the angle of rotation of the selected part in relation to the placement surface is calculated. This is performed by and/or classification AI model (“M-RotEst”). In this case, M-RotEst is one example of an angle recognition ML model in accordance with the present description.

3.) In a next step, a third AI model (“M(parts ID, adopted stable pose, angle of rotation)”) is applied to the ROI, in which the selected part is situated. Here, the variables already determined in the preceding steps: type of the part (parts ID), adopted stable pose, and the ascertained angle of rotation of the part are used as input variables. By way of example, a “deep neural network”, a “random forest” model or a comparable ML model can be used for this third AI model. Furthermore, a 3D model of the selected part is selected from a corresponding database, for example. In a further step, an image evaluation method, such as SURF, SIFT or BRISK, is then applied to the ROI. Here, the recognized features of the 3D model of the selected part and also in the captured image of the part are compared. This last-mentioned step here produces the transformation data between the 3D model of the selected part and the selected part in the captured camera image in reality. These transformation data can then be used to transform gripping points identified in the 3D model into the real space in such a way that the coordinates of the gripping points for the selected part are then available. This third AI model M(parts ID, adopted stable pose, angle of rotation) here is one example of a transformation ML model in accordance with the present description.

A description is given below of how the abovementioned software or the abovementioned ML models (e.g. M-Seg, M-RotEst and M(parts ID, adopted stable pose, angle of rotation)) can be configured or trained for carrying out the method described.

For this purpose, a 3D model of the part to be gripped is made available as an input, possible gripping points for the part being specified or identified in the 3D model.

Furthermore, possible stable poses of the part on a planar surface are then determined in a first step. Here, a possible stable pose of this type is a pose in which the object is at equilibrium and does not tip over. In the case of a coin, this is, for example, also a pose in which the coin is standing on its edge.

These possible stable poses can be ascertained, for example, by the objects being dropped onto a planar surface with a wide variety of initial conditions. This can be done in reality or else in a corresponding physical simulation using a 3D model of the part. Both in the simulation and in reality, this is then followed by waiting until the part is no longer moving. The position then attained is regarded as a stable pose, and captured as such. A further option for ascertaining possible stable poses is to ascertain those positions in which the selected part touches a planar surface at (at least) three points, the object then not penetrating the surface at any other point. The stable poses ascertained in one of the ways described are then each assigned a unique identifier.

Afterward, training data are then generated for the segmentation ML model (M-Seg). Here, the training data consist of a set of images with captured objects, annotated or labeled with the respective location of the object, ID information or a type of the object, and a correspondingly adopted stable pose. These data can be generated, for example, by various objects being positioned in corresponding stable poses in the real world. Alternatively, 3D models of the objects can also be arranged in respective stable positions virtually using ray tracer software or a game engine, corresponding images of these objects then subsequently being generated artificially.

Labels are then generated for the corresponding images of the objects. The label for each of the objects consists of a rectangular virtual bounding box (x1, y1, x2, y2), the object type and an identifier for the adopted stable pose.

If the optional angle recognition model M-RotEst is used, the angle of rotation of the selected part relative to a surface normal of the placement surface is furthermore assigned as a label. If a simulation is used to generate such data, for example, using a ray tracer engine, these data for labeling the captured images can be generated automatically.

These entire data generated in this way can then be used to train a deep neural network, for example, where it is possible to use, for example, standard architectures, such as YOLO, for the model M-Seg and a convolutional neural network for the regression or the regression model.

Once again in a subsequent step, reference image representations of the respective parts in the respective stable positions are then generated. This can once again be achieved using real objects or can be generated via the virtual simulation mentioned. Here, the use of real objects has the disadvantage that the labeling has to be done manually. If virtual 3D models are used, then the data necessary for labeling can be generated automatically and the labeling can therefore also proceed automatically. Furthermore, the transformation data can also be ascertained more accurately if the images are generated on the basis of a physical simulation with 3D models.

The generated transformation data then allow gripping points identified in the 3D model of a specific part with the aid of the above-described methods in accordance with disclosed embodiments to be transformed into the coordinates of corresponding gripping points of a real captured part, with the result that a gripping device can grip the real part at the corresponding gripping points using these coordinates.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in greater detail by way of example below with reference to the accompanying figures, in which:

FIG. 1 shows an exemplary system for gripping an object in accordance with the invention;

FIG. 2 shows an exemplary 3D model with gripping points and represented stable poses in accordance with the invention;

FIG. 3 shows exemplary methods for ascertaining stable poses of an object in accordance with the invention;

FIG. 4 shows exemplary methods for training an ML model in accordance with the invention;

FIG. 5 shows exemplary methods for generating training data for an ML model in accordance with the invention;

FIG. 6 shows an exemplary method for gripping an object in accordance with the invention;

FIG. 7 shows an exemplary captured camera image of objects including a representation of the associated 3D models in accordance with the invention;

FIG. 8 shows a second exemplary embodiment system for gripping an object in accordance with the invention; and

FIG. 9 shows a third exemplary embodiment of a system for gripping an object in accordance with the invention.

### DETAILED DESCRIPTION OF THE EXEMPLARY EMBODIMENTS

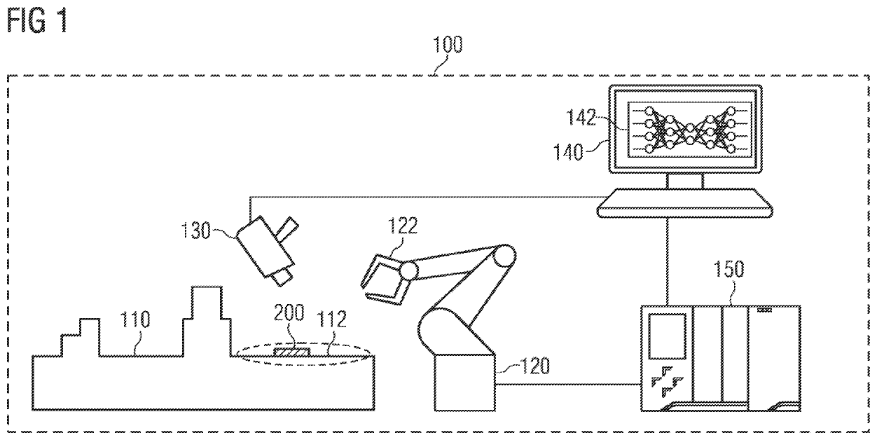

FIG. 1 shows a gripping system 100 as an exemplary embodiment of a system in accordance with the present disclosure. This exemplary gripping system 100 is configured for recognizing, selecting and gripping and transporting objects 200 on a transport device 110.

For this purpose, FIG. 1 illustrates a parallelepipedal gripping object 200 that, within a transport device 110, is transported to a planar placement surface 112 and is placed there. Furthermore, a camera 130 for capturing the placement surface 112 with the gripping object 200 is provided, where the camera is connected to an industrial PC 140. Here, the industrial PC 140 comprises image evaluation software comprising a neural network 142. Using this image evaluation software with the neural network 142, the images captured by the camera 130 are evaluated such that the gripping object 200 and further possible objects are recognized and data for gripping points for gripping this object are ascertained by a method described in greater detail below.

These data for the gripping points for gripping the object 200 are then communicated from the industrial PC to a modular programmable logic controller (PLC) 150, where these data are processed further and then communicated to a robot 120 having a gripper 122. The robot 120 then drives its gripper 122 using these data such that the gripper 122 grips the object 200 at the gripping points provided therefor and transports it to a further production step, not illustrated in FIG. 1.

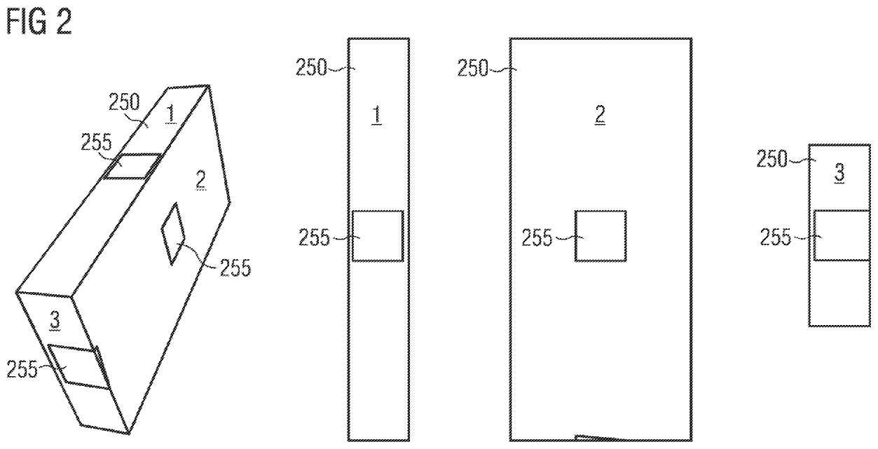

FIG. 2 shows a 3D model 250 of the parallelepipedal gripping object 200. Here, the 3D model 250 of the parallelepipedal gripping object 200 in FIG. 2 is illustrated both in perspective view (on the far left in FIG. 2) and in its three stable poses in accordance with the present disclosure. In FIG. 2, furthermore, three of the six sides of the 3D model 250 of the parallelepiped 200 are identified by corresponding numerals. The stable poses 1, 2 and 3 of the 3D model 250 are each illustrated here in a view from above.

Furthermore, in the 3D model 250, gripping points 255 respectively provided for gripping the corresponding object are represented as black squares. Here, the gripping points 255 are such points at which a corresponding parallelepiped 200 can advantageously be gripped by a gripping device 120, 122. Here, the 3D model 250 was created by a corresponding 3D CAD program. Within this program, the corresponding model gripping points 255 were identified in the 3D model 250.

The “stable pose 1” illustrated in FIG. 2 shows a pose of the 3D model 250 in which the 3D model 250 becomes situated on the narrow long side, and the narrow long side that is parallel thereto, and that is identified by a numeral 1 in FIG. 2, faces upward. In the case of the “stable pose 2” illustrated in FIG. 2, the large long side identified by a numeral 2 in FIG. 2 faces upward. The “stable pose 3” illustrated in FIG. 2 correspondingly shows a pose in which the short narrow side of the 3D model 250 which is identified by a numeral 3 in FIG. 2 faces upward.

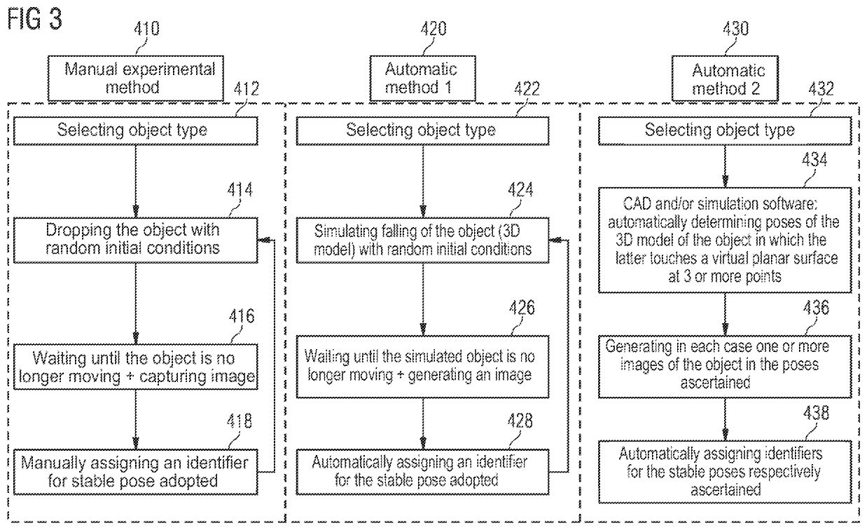

The stable poses illustrated in FIG. 2 may have been ascertained by a method in accordance with the present disclosure. Some examples of such a method are explained in greater detail in association with the following FIG. 3.

FIG. 3 shows three exemplary methods 410, 420, 430 for ascertaining one or more stable poses of an object or article.

In a first, manual method 410, a first step 412 involves selecting a specific object type for which one or more stable poses are intended to be ascertained.

In a next step 414, this object is dropped onto a planar surface with random initial conditions. Here, the random initial conditions comprise a randomly ascertained height above the planar surface and also an arbitrary initial velocity in terms of direction and speed for the selected object.

Afterward, a step 416 involves waiting until the dropped object is no longer moving. Once this object has come to rest, an image of the object on the planar surface is captured, for example, by a camera.

A next step 418 then involves identifying the stable position adopted by the object on the planar surface, and ascertaining a unique identifier for the stable position adopted. This unique identifier for the stable position adopted is then assigned to the captured image.

A combination (ascertained in this way) of a captured image with a unique identifier for the stable pose adopted by the object in the image can then be used, for example, for later comparable measurements in order to assign correspondingly unique identifiers to stable positions. In this regard, with the aid of such image-identifier combinations, for example, it is possible to establish a database regarding stable poses of objects.

Furthermore, such an image-identifier combination can be used for training an ML model in accordance with the present disclosure.

In a further advantageous embodiment, following method step 418, method step 414 is once again performed, for example, with the same object and different initial conditions. In this way, once again a new image-identifier combination is then generated and can then be used in procedures as already described above. This is identified by an arrow between the method steps 418 and 414 in FIG. 3.

In this way, the method can be performed until, for example, there are enough image-identifier combinations available for a database or else for training of a corresponding ML model.

This can be the case, for example, if there are enough image-identifier combinations available for each of the possible objects and each of the possible stable poses of such objects.

FIG. 3 furthermore shows a first automatic method 420 likewise for ascertaining stable poses of one or more objects. In this case, a first step 422 also involves selecting an object for which correspondingly stable poses are also intended to be determined. A corresponding 3D model is then selected with respect to this object. Such 3D models may be created or may have been created by corresponding 3D CAD programs, for example.

A next step 424 then involves simulating the falling of such an object onto a planar surface using the 3D model of the object onto a virtual surface using a simulation environment with a physical simulation (for example, via a “game engine”). Here, the initial conditions can be chosen randomly with regard to speed and direction, for example.

Subsequently, in a step 426, the simulation is continued until the simulated object is no longer moving within the scope of normal measurement accuracy. Then an image of the 3D model of the object that has come to rest on the virtual planar surface is generated with the aid of the simulation environment. Here, the image is generated in a manner such that it corresponds to a camera recording of a real object corresponding to the 3D model on a real planar surface corresponding to the virtual surface.

Afterward, in the next step 428, a unique identifier for the stable pose adopted by the 3D model in the image is assigned to this created or generated image.

As in the example above, this image-identifier combination can then be used for establishing a corresponding database or for the training of a corresponding ML model.

In one advantageous embodiment, the method mentioned can then be performed a number of times by virtue of the method step 424 then once again succeeding the method step 428. This succeeding step 424 then involves simulating the falling of a 3D model with different initial conditions, for example. This is represented by a corresponding linking arrow between method step 428 and method step 424 in FIG. 3.

In this way, it is possible once again, as already described above, to generate as many image-identifier combinations as are necessary for establishing a corresponding database or for the training of a corresponding ML model.

Furthermore, FIG. 3 shows a second automatic method 430 for ascertaining stable object poses. Here, a first step 432 also involves selecting an object for which stable object poses are subsequently determined.

This second automatic method once again works with the use of a 3D model of the selected object type. Here, a next method step 434, using corresponding simulation or CAD software, involves ascertaining those poses of the selected 3D model on a virtual surface in which the 3D model touches the virtual planar surface at three or more points, without the 3D model penetrating this planar surface at further points.

From each of these ascertained poses of the 3D model on the virtual planar surface, one or more images of the 3D model on the virtual planar surface is/are then generated in a next step 436, comparable to the first automatic method 420. In this case, given a plurality of images, different virtual camera positions can be used for each of the images.

In a next method step 438, the corresponding images created are then each assigned a unique identifier for the stable pose adopted by the object in the respective image.

These identifier-image combinations can then once again be used for establishing a corresponding database for stable poses of objects and/or for the training of one or more corresponding ML models.

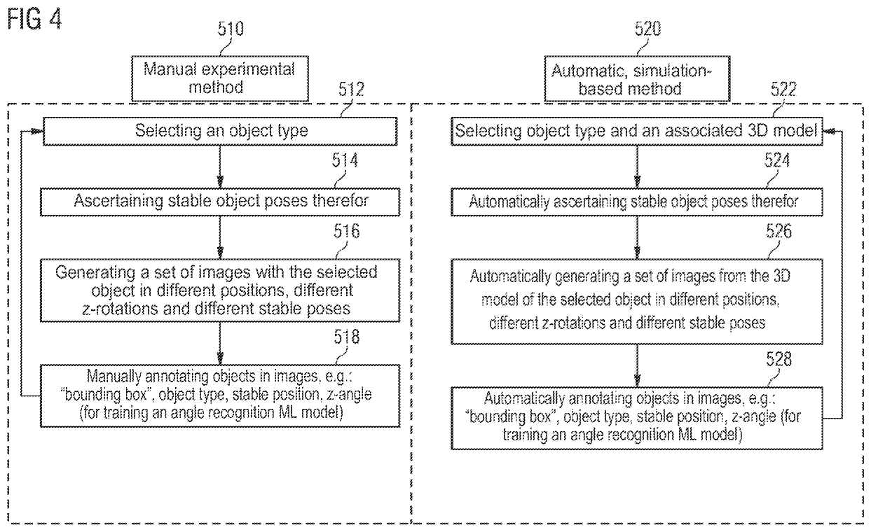

FIG. 4 shows two examples of methods 510, 520 for generating training data for a recognition ML model and/or an angle recognition ML model. Here, the first method 510 illustrated on the left in FIG. 4 is provided for ascertaining training data for a recognition ML model and/or an angle recognition ML model manually or in a partly automated manner. In this case, a first step 512 involves selecting a specific object type for which corresponding training data are intended to be generated.

A further step 514 involves ascertaining stable object poses for this object type on a planar surface. By way of example, methods in accordance with the present disclosure can be used here.

A subsequent work step 516 involves generating a plurality of images using the selected object in different positions, different stable poses and at different angles of rotation about a surface normal of the planar surface, or selecting them, e.g., from a database or image collection.

In a subsequent work step 518, the respective images are assigned identifier data for the object, for example, data regarding a virtual box around the object, an object type, an identifier for the adopted stable pose and/or a location. If training data are generated for an angle recognition ML model, the identifier data furthermore also comprise an angle of rotation as well.

Afterward, the same method steps beginning with method step 512 are implemented once again with a further object type. This loop is repeated until training data have been generated for all those objects that are required for an application of the corresponding ML model.

The automatic, simulation-based method 520 illustrated on the right-hand side of FIG. 4 begins once again, in a first method step 522, with selecting an object type and a correspondingly associated 3D model for this object type. Here, the 3D model can be configured in accordance with the present disclosure, for example.

Afterward, in the next method step 524, once again the stable object poses are ascertained automatically using the 3D model of the selected object type. This automatic ascertainment can be effected in accordance with the present disclosure, for example.

A next method step 526 involves automatically generating a set of images using the 3D model of the selected object type in different positions and stable poses and at different angles of rotation. These images can, for example, once again be generated in accordance with the present disclosure, for example, using a corresponding ray tracer engine.

In a next method step 528, the generated images are then automatically annotated or labeled with corresponding characteristic data. Such characteristic data are, for example, information regarding a virtual box around the represented object, an object type, an identifier regarding a stable pose of the object and/or a position of the object. If the training data are provided for the training of an angle recognition ML model, then the characteristic data furthermore comprise an angle of rotation. The characteristic data mentioned can be automatically annotated or labeled because, owing to the virtual generation of the images with the aid of a simulation environment and a corresponding ray tracer engine, these data are already known during the generation of the image.

Afterward, the method steps beginning with the method step 522 are performed for a further object type. This loop is implemented until training data have been generated for all those objects that are required for an application of the corresponding ML model.

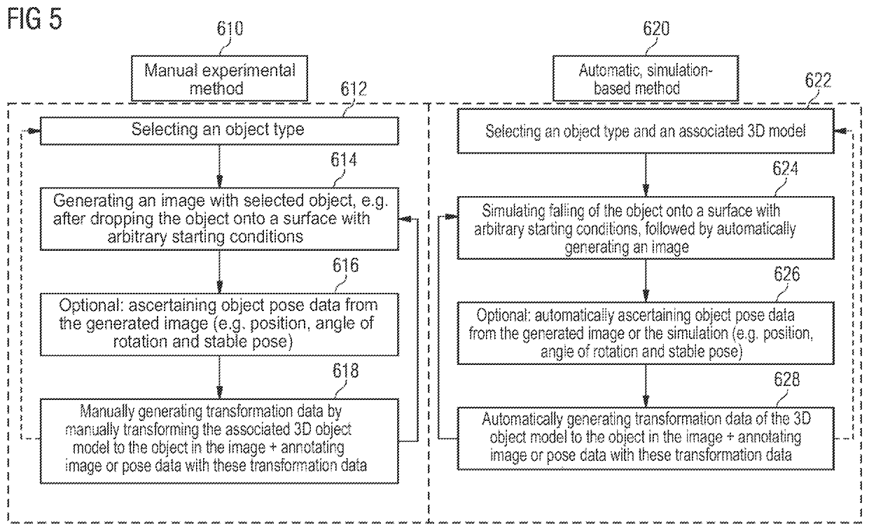

FIG. 5 illustrates two methods 610, 620, which are exemplary methods for generating training data for a transformation ML model.

A first, manual method 610 is illustrated on the left-hand side of FIG. 5. Here, a first work step 612 once again involves selecting a specific object type for which corresponding training data are then generated.

A second work step 614 then involves generating an image using the selected object type, e.g., after the selected object has been dropped onto a planar surface with arbitrary initial conditions (e.g. regarding height and starting velocity vector).

A next, optional step 616 then involves ascertaining object pose data from the generated image. Such object pose data can be or can comprise, for example, a position of the object, an identifier for the object, information regarding a virtual bounding box around the object, an angle of rotation and/or an adopted stable pose.

Subsequently, a next step 618 then involves determining transformation data for the transformation of a 3D model of the selected object into the pose of the model in the generated image. This can be achieved, for example, in a manner such that on a computer screen, for example, the captured image is superimposed with a representation of the 3D model and, via manual transformation actions on the part of a user, the 3D model image of the object is transformed or rotated and displaced and escalated such that it matches the object represented in the generated image. From the transformation operations used here, the desired transformation data can then be ascertained in a manner known to a person skilled in the art.

Afterward, these transformation data are then assigned, for example, to the generated image or to the ascertained object pose data. These annotated or labeled images or annotated or labeled pose data can then be used for the training of a corresponding transformation ML model.

Subsequently, the method steps beginning with method step 614 are repeated until enough training data have been generated for the selected object type. This loop is symbolized by a corresponding arrow on the right-hand side of the manual experimental method 610 illustrated.

Once enough training data have been generated for a specific object and following the last-performed method step 618 for annotating an image or pose data, the manual method 610 is begun again with the first method step 612 for selecting a new object type, after which corresponding training data are ascertained for this further object type. This loop is symbolized by a dashed arrow on the left-hand side of the manual method 610 illustrated in FIG. 5.

The above-explained sequence of the manual method 610 is performed until enough training data have been ascertained for all relevant object types.

The right-hand side of 5 illustrates an exemplary automatic method 620 enabling training data to be generated for a transformation ML model in an automated and simulation-based manner. Here, a first method step 622 also involves ascertaining a specific object type and a corresponding 3D model therefor.

Afterward, a next method step 624 involves automatically generating an image of the selected 3D model in an arbitrary position, with an arbitrary angle of rotation and in an arbitrary stable pose. This can be effected via a physical simulation, for example, in which the falling of a corresponding object onto a planar surface is simulated with arbitrary starting conditions (e.g., regarding height and velocity vector), and then an image of the object is generated with the aid of a corresponding ray tracer engine once the object has again come to rest in the simulation. This generation of an image can be configured in accordance with the present disclosure, for example.

Given known stable poses of the object, the images can, e.g., also be generated by representing or rendering the 3D model of the object with different positions, angles of rotation and stable poses in each case in an image, e.g., via a corresponding 3D modeling or 3D CAD tool.

A next, optional method step 626 involves automatically gathering object pose data from the generated image or directly from the corresponding simulation environment or the corresponding 3D modeling or 3D CAD tool. Such object pose data can once again comprise for example a position, information regarding a virtual bounding box around the object, an angle of rotation and/or an identifier for an adopted stable pose of the object.

A subsequent method step 628 then involves automatically generating transformation data of the 3D model of the object into the object situated in the simulation environment or the object represented in the generated image. This can be achieved, for example, by importing the 3D model of the object into the simulation environment and subsequent automatically ascertained or indirect transformation operations such that the imported 3D model of the object is converted into the object situated on the planar surface in the stable pose adopted. This sequence of transformation operations can then already represent the corresponding transformation data. Furthermore, alternatively, this sequence of transformation operations can be converted into the transformation data in a manner known to a person skilled in the art. Then, for example, the generated image or the pose data ascertained with respect thereto is/are annotated or labeled with these corresponding transformation data. The images or pose data thus labeled can then be used as training data for a corresponding transformation ML model.

As already mentioned in connection with the manual method 610 in FIG. 5, via a first method loop back to method step 624 here as well, it is possible first to generate further images for the selected object type and thus also further training data for this object type for a transformation ML model. This first loop is identified by an arrow on the left-hand side of the method sequence of the automatic method 620 in FIG. 5.

Once enough training data have been generated for a specific object type, in a second superimposed method loop, beginning once again with the first method step 622, a new object type is selected and afterward the method explained above is performed for this further object type. This second superimposed method loop is represented by a corresponding dashed arrow from the last method step 628 to the first method step 622 on the right-hand side of the illustration of the automatic method 620 in FIG. 5.

The entire automatic method 620, as explained above, is then performed until, for all required object types, enough training data are available for training a corresponding transformation ML model.

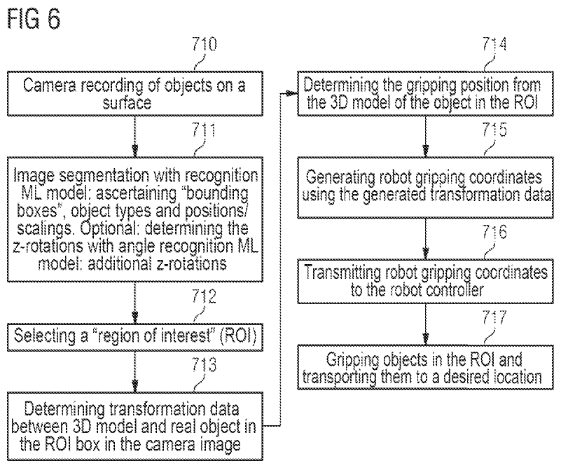

FIG. 6 shows an exemplary method sequence for gripping an object from a surface using a recognition ML model or an angle recognition ML model and a transformation ML model in accordance with the present disclosure.

The method illustrated in FIG. 6 is explained here in greater detail below based on the exemplary system illustrated in FIG. 1.

In a first method step 710, the camera 130 makes a camera recording of the parallelepiped 200 situated on the placement surface 112. In the next method step 711, this camera image is communicated to the industrial PC 140, on which corresponding image evaluation software comprising a corresponding recognition ML model or comprising a corresponding angle recognition ML model is implemented. Here, the neural network 142 illustrated in FIG. 1 is one example of such a recognition ML model or such an angle recognition ML model.

In method step 711, using the recognition ML model, a virtual bounding box around the imaged parallelepiped 200 is determined, and an object type for the captured parallelepiped 200 and its position and scaling in the recorded image and a stable position adopted in this case are determined. This ascertainment of the parameters mentioned can be configured, for example, as explained in greater detail in the present disclosure. Optionally, an angle recognition ML model can also be used, in which case an angle of rotation about a surface normal of the placement surface 112 is also ascertained as an additional parameter. This ascertainment can also be configured, for example, in accordance with the present disclosure.

For the case where a plurality of objects are represented in the captured image, method step 711 is performed for each of the objects represented.

A further method step 712 involves selecting, for example, that virtual bounding box in which the object that is intended to be gripped by the robot 120 is situated. In the present example, the selected bounding box corresponds to that around the parallelepiped 200.

Afterward, in a next method step 713, using a transformation ML model correspondingly trained for this application, transformation data for a transformation of a 3D model 250 for the parallelepiped 200 into the parallelepiped 200 situated on the placement surface 112 are generated. For this purpose, for example, characteristic pose data of the parallelepiped 200, such as its position, information concerning the virtual bounding box around the parallelepiped, the adopted stable pose, an angle of rotation relative to a surface normal of the placement surface 112 or comparable pose data are input into the transformation ML model. The transformation ML model then supplies the corresponding transformation data for the transformation of the 3D model 250 of the parallelepiped 200 into the parallelepiped 200 situated on the placement surface 112.

Afterward, a next method step 714 involves determining coordinates of the gripping points 255 captured in the 3D model 250 of the parallelepiped 200.

Afterward, in a further method step 715, the transformation data generated in method step 713 are then applied to the coordinates of the model gripping points 255 that were ascertained in method step 714, in order to then determine therefrom specific robot gripping coordinates for gripping the parallelepiped 200 on the placement surface 112. Here, the corresponding robot gripping coordinates are configured such that the gripper 122 of the robot 120 grasps the parallelepiped 200 at one or more gripping points, these gripping points corresponding to model gripping points 255 in the 3D model 250 of the parallelepiped 200.

While method steps 711 to 715 proceed in the industrial PC 140, for example, the robot gripping coordinates generated in method step 715 are then communicated from the industrial PC 140 to the PLC 150 in a next method step 716.

In a final method step 717, these data are subsequently converted into corresponding control data for the robot 120 and transferred to the robot 120 by the PLC 150. Said robot then grips the parallelepiped 200 at the calculated gripping points in order to subsequently transport it to a desired placement location.

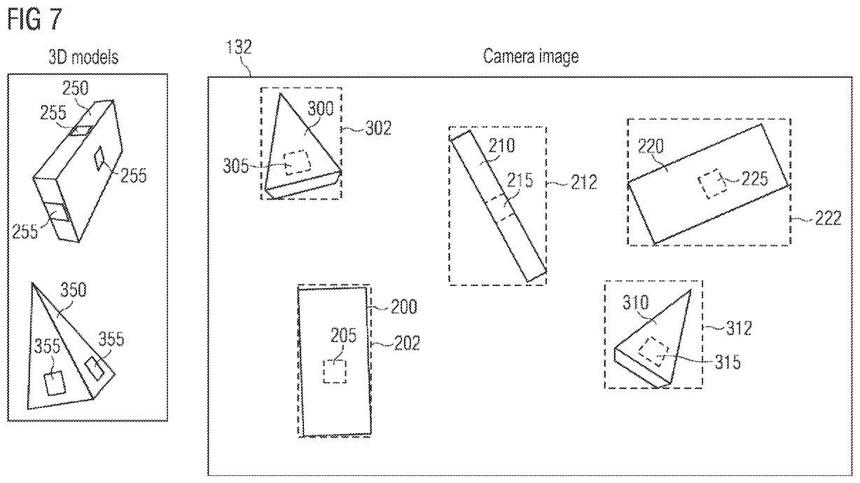

FIG. 7 shows two 3D models 250, 350 on the left-hand side, in which case, besides the 3D model 250 of the parallelepiped 200 already illustrated in FIG. 2, furthermore a 3D model 350 of a pyramid is also illustrated. In the 3D model 250 of the parallelepiped 200, once again corresponding model gripping points 255 are identified, which identify suitable places at the corresponding parallelepiped 200 at which a gripper for gripping the parallelepiped 200 can advantageously take hold. Model gripping points 355 for gripping a corresponding pyramid are correspondingly identified in the 3D model 350 of the pyramid.

A camera image 132 is illustrated by way of example on the right-hand side of FIG. 7, in which image parallelepipeds 200, 210, 220 and pyramids 300, 310 situated on a corresponding planar surface were captured. Here, the three parallelepipeds 200, 210, 220 illustrated correspond to the 3D model 250 of the parallelepiped illustrated on the left-hand side of FIG. 7. The two pyramids 300, 310 correspond to the 3D model 350 of the pyramid illustrated on the left-hand side of FIG. 7.

Here, a first parallelepiped 200 represented in the camera image 132 is situated in the second stable pose for this parallelepiped 200 such as was explained in the context of the explanations concerning FIG. 2. In this second stable pose, the large long side identified by the numeral 2 in FIG. 2 faces upward. Furthermore, on the parallelepiped 200, a corresponding gripping point 205 is identified in the camera image 122, where gripping point corresponds to the model gripping point 255 in the second stable pose as illustrated in FIG. 2.

With a method in accordance with the present disclosure, transformation data can then be calculated, for example, which enable the parameters for the corresponding model gripping point 255 to be converted into coordinates for the gripping point 205 of the parallelepiped 200 in the camera image 132. With the aid of these transformation data, control data for a robot can then be ascertained, for example, in order for the robot to grasp the parallelepiped 200 at the gripping point 205 and thus transport it, using a suction gripper, for example.

Furthermore, the camera image 132 shows a virtual bounding box 202 around the represented parallelepiped 200. This virtual bounding box 202 can be used to define, for example, a corresponding “region of interest” (ROI) for this parallelepiped 200. Furthermore, from the data concerning this virtual bounding box 202 for the represented parallelepiped 200, it is possible to ascertain further characteristic variables for the parallelepiped, such as a position, a scaling factor or an estimation for an angle of rotation and/or a stable pose.

In a comparable manner, FIG. 7 illustrates a second parallelepiped 210, which is situated in a first stable pose such as was explained in FIG. 2. Here, the short long side of the parallelepiped 210 that is designated by the numeral 1 in FIG. 2 faces upward. Once again, a corresponding parallelepiped gripping point 215 is represented in the camera image 132, where the gripping point corresponds to the model gripping point 255 corresponding to the image representation of the view of the stable pose 1 of the 3D model 250 of the parallelepiped in FIG. 2. Furthermore, a virtual bounding box 212 around the second parallelepiped 210 is also represented here.

Furthermore, FIG. 7 shows a third parallelepiped 220 in the camera image 132, where the third parallelepiped is once again situated in the second stable pose in accordance with FIG. 2. Here, a corresponding gripping point 225 is also again depicted, which corresponds to the model gripping point 255 in the second stable pose as illustrated in FIG. 2. The third parallelepiped 220 is also assigned a corresponding virtual bounding box 222, which is represented in the camera image 132.

Correspondingly, the camera image furthermore shows a first pyramid 300 with a gripping point 305 visible in the corresponding stable pose, where the gripping point corresponds to one of the pyramid model gripping points 355. A corresponding virtual bounding box 302 is depicted around this first pyramid 300 and can also be used, for example, for selecting the pyramid for subsequent gripping at the gripping point 305.

The camera image 132 furthermore shows a second pyramid 310 in a stable pose for such a pyramid 300, 310. A gripping point 315 corresponding to one of the pyramid model gripping points 355 is also depicted on this second pyramid 310 captured in the camera image 132. In the camera image 132, a corresponding virtual bounding box 312 is also depicted for this second pyramid 310.

Such a camera image 132 could be captured, for example, if three parallelepipeds 200, 210, 220 in accordance with the 3D model 250 of these parallelepipeds 200, 210, 220 and also two pyramids 300, 310 in accordance with the 3D model 350 of these pyramids 300, 310 were situated on the placement surface 112 of the transport device 110 as illustrated in FIG. 1.

With an image evaluation method in accordance with the present disclosure, it is then possible to ascertain, for example, the virtual bounding boxes 202, 212, 222, 302, 312, and also the respective positions, stable poses and angles of rotation of the represented objects 200, 210, 220, 300, 310. By way of example, the first parallelepiped 200 can then be selected in a corresponding selection step.

With a method in accordance with the present disclosure, transformation data can then be ascertained from the ascertained position data and parameters of the first parallelepiped 200 in the camera image 132, where the transformation data can be used to transform the 3D model 250 of the parallelepiped 200 into the parallelepiped in reality that is situated in the camera image 132. These transformation data can then be applied to convert the parallelepiped model gripping points 255 into coordinates of the gripping points 205 of the parallelepiped 200 in the camera image 132. Using these coordinates for the gripping points 205 of the selected parallelepiped 200, it is then possible to ascertain robot data for controlling a robot having a suction gripper, for example. This can then grasp the parallelepiped 200 at the parallelepiped gripping points 205 and transport it.

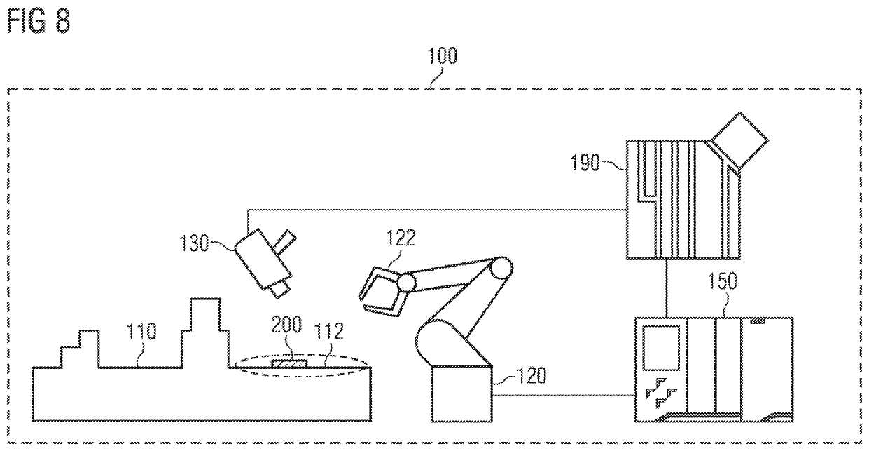

FIG. 8 shows a modification of the gripping system 100 already illustrated in FIG. 1. In the gripping system 100 illustrated in FIG. 8, the industrial PC 140 illustrated in FIG. 1 for image evaluation is replaced here by an edge device 190, which is likewise configured at least inter alia for evaluating images from the camera 130. Here, the edge device can be configured, for example, in accordance with the present disclosure and, besides the coupling to the PLC 150, for example, can also be connected to a cloud, not illustrated in FIG. 8. Here, provision can furthermore be made for the image evaluation methods for evaluating the images captured by the camera 130, or at least parts thereof, to proceed in the cloud.

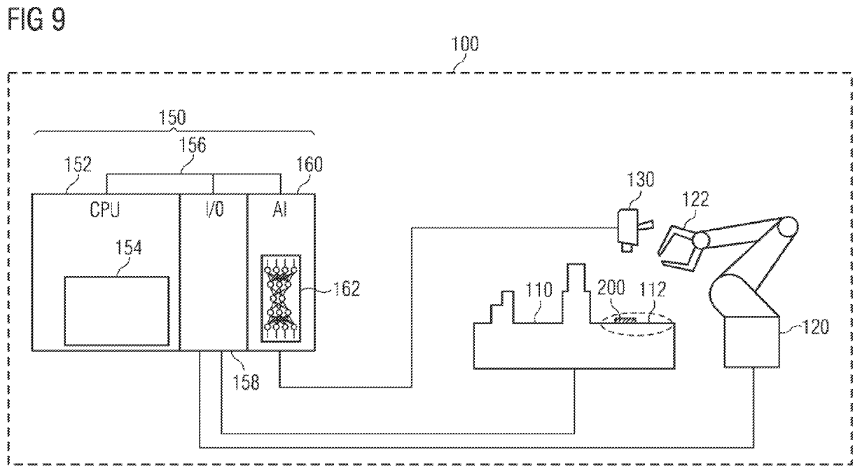

FIG. 9 illustrates a further modification of the gripping systems 100 illustrated in FIGS. 1 and 8, where the images captured by the camera 130 are evaluated in the PLC 150 in the gripping system 100 illustrated in FIG. 9. For this purpose, the PLC 150 comprises a central controller assembly 152 having an execution environment 154 for executing a corresponding control program, inter alia for controlling the transport device 110 and also the robot 120. Furthermore, the PLC 150 comprises an input/output assembly 158, via which the communication between the PLC 150 and the transport device 110 and also the robot 120 is effected. The PLC 150 furthermore comprises a functional module 160 for executing an image evaluation method for evaluating images from the camera 130, the functional module 160 comprising a neural network 162, which constitutes one exemplary embodiment for a recognition ML model in accordance with the present disclosure, an angle recognition ML model in accordance with the present disclosure and/or a transformation ML model in accordance with the present disclosure.

Here, the central module 152, the input/output module 158 and the functional module 160 of the PLC 150 are coupled to one another via an internal backplane bus 156. The communication between these modules 152, 158, 160 is effected via said backplane bus 156, for example.

Here, the PLC 150 can be configured, for example, such that, in the context of a method in accordance with the present disclosure, all those work steps that use an ML model are executed in the functional module 160 of the PLC 150, while all other work steps in the context of the inventive method are executed by a control program executed in the execution environment 154 of the central module 152.

Alternatively, the PLC 150 can, for example, also be configured such that, in the context of a method in accordance with the present disclosure, all work steps associated with the evaluation of images, in particular images from the camera 130, are executed in the functional module 160, while the work steps for controlling the transport device 110 and the robot 120 are executed by a control program executed in the execution environment 154 of the central controller assembly 152.

In this way, the PLC 150 can be configured very effectively for executing a method in accordance with the present disclosure because computationally intensive special tasks, such as the handling of the ML models mentioned or the evaluation of images, are delegated to the specific functional module 160, and all other method steps can be executed in the central module 152.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for ascertaining control data for a gripping device for gripping an object, the method comprising:
capturing an image of the object;
determining at least one object parameter for the captured object;
ascertaining control data for the gripping device for gripping the object at at least one gripping point; said ascertaining the at least one gripping point of the object being effected utilizing information regarding at least one possible stable pose of the object;
wherein the at least one possible stable pose of the object is established such that all pose data of the object which are convertible into one another via at least one of a displacement and a rotation about a surface normal of a support surface on which the object lies are assigned to said at least one possible stable pose; and
wherein at least one of (i) said determining the at least one object parameter and (ii) said ascertaining the control data for the gripping device is effected utilizing information regarding the at least one possible stable pose of the object.

16. The method as claimed in claim 15, wherein said ascertain the at least one gripping point further comprises:
selecting a 3D model for the object using the at least one object parameter;
determining at least one model gripping point from the 3D model of the object; and
determining the at least one gripping point of the object utilizing the model gripping point.

17. The method as claimed in claim 15, wherein the utilization of information regarding at least one possible stable pose is configured as utilization of an machine learning model; and wherein the ML model was at least one of trained and configured via application of a ML method to ascertained information regarding the at least one possible stable pose.

18. The method as claimed in claim 16, wherein the utilization of information regarding at least one possible stable pose is configured as utilization of an machine learning model; and wherein the ML model was at least one of trained and configured via application of a ML method to ascertained information regarding the at least one possible stable pose.

19. The method as claimed in claim 16, wherein said ascertaining the at least one gripping point of the object using the model gripping point is one of (i) effected utilizing a further ML model which is trained and configured via application of the ML method to transformation data regarding possible transformations of a predefined or predefinable initial position into possible poses of the object and (ii) effected aided by application of an image evaluation method to the captured image of the object.

20. The method as claimed in claim 15, wherein said determining the at least one object parameter further comprises:
ascertaining position data of the object,
wherein the position data further comprises information regarding a stable pose adopted by the object.

21. The method as claimed in claim 15, wherein at least one of said determining the at least one object parameter, ascertaining ID information, ascertaining position data, determining a pose of the object, determining a virtual bounding box around the object and/or determining a stable pose adopted by the object are effected utilizing the information regarding at least one possible stable pose.

22. The method as claimed in claim 15, wherein when capturing the image of the object, further objects are captured and, in a context of determining the at least one object parameter of the object, further more in each case at least one further object parameter regarding each of the further objects is also ascertained; and wherein after ascertaining object parameters regarding the object and the further objects, selection of the object is effected.

23. A method for gripping an object, wherein at least one gripping point of the object is ascertained and then the object is subsequently gripped by a gripping device in accordance with the method as claimed in claim 15; and wherein the gripping device engages at the at least one gripping point when gripping the object.

24. A system for gripping an object, the system comprising:
an optical capture device for capturing an image of the object; and
a data processor for at least one of determining at least one object parameter of the object and ascertaining control data for a gripping device for gripping the object;
wherein the system is configured to:
ascertain control data for the gripping device for gripping the object at at least one gripping point; said ascertaining the at least one gripping point of the object being effected utilizing information regarding at least one possible stable pose of the object;
wherein the at least one possible stable pose of the object is established such that all pose data of the object which are convertible into one another via at least one of a displacement and a rotation about a surface normal of a support surface on which the object lies are assigned to said at least one possible stable pose; and
wherein at least one of (i) said determining the at least one object parameter and (ii) said ascertaining the control data for the gripping device is effected utilizing information regarding the at least one possible stable pose of the object.

25. The system as claimed in claim 24, further comprising: a gripping device.

26. The system as claimed in claim 24, wherein the data processor is one of configured as a modular programmable logic controller having a central module and a further module and comprises the programmable logic controller; and
wherein said determining the at least one object parameter of the object is effected utilizing the further module.

27. The system as claimed in claim 25, wherein the data processor is one of configured as a modular programmable logic controller having a central module and a further module and comprises the programmable logic controller; and
wherein said determining the at least one object parameter of the object is effected utilizing the further module.

28. The system as claimed in claim 26, wherein at least one of:
(i) said determining the at least one object parameter of the object is effected utilizing a machine learning model, the further module comprising the ML model and
(ii) said ascertaining the control data for the gripping device is effected utilizing a further ML model, the further module comprising the further ML model.

29. The system as claimed in claim 24, wherein the data processing device one of comprises an edge device and is configured as an edge device; and wherein said determining the at least one object parameter of the object is effected utilizing the edge device.

30. The system as claimed in claim 25, wherein the data processing device one of comprises an edge device and is configured as an edge device; and wherein said determining the at least one object parameter of the object is effected utilizing the edge device.

31. The system as claimed in claim 29, wherein at least one of:
(i) said determining the at least one object parameter of the object is effected utilizing an ML model, the edge device comprising the ML model and
(ii) ascertaining the control data for the gripping device comprises utilizing a further ML model, the edge device comprising the further ML model.
